(19) United States
(12) Patent Application Publication
(10) Pub. No.: US 2021/0267143 A1
(43) Pub. Date: Sep. 2, 2021

(54) METHODS FOR INCREASING DIGESTIBILITY OF HIGH-PROTEIN FOOD COMPOSITIONS

(71) Applicant: MycoTechnology, Inc., Aurora, CO (US)

(72) Inventors: Bhupendra Kumar Soni, Aurora, CO (US); Anthony J. Clark, Aurora, CO (US); James Patrick Langan, Aurora, CO (US)

(21) Appl. No.: 17/322,881

(22) Filed: May 17, 2021

Related U.S. Application Data
(63) Continuation-in-part of application No. 17/074,630, filed on Oct. 20, 2020.
Application No. 17/074,630 is a continuation of application No. 16/025,365, filed on Jul. 2, 2018, now Pat. No. 10,806,101.
Application No. 16/025,365 is a continuation-in-part of application No. 15/488,183, filed on Apr. 14, 2017, now Pat. No. 10,010,103.
(60) Provisional application No. 63/025,523, filed on May 15, 2020.
(60) Provisional application No. 62/322,726, filed on Apr. 14, 2016.

(51) Int. Cl. A01G 18/20; A23J 3/14; A23L 19/00

(52) U.S. Cl. CPC A01G 18/20; A23J 3/14; A23V 2200/16; A23V 2200/15; A23V 2002/00; A23L 19/01

(57) ABSTRACT

Disclosed is a method to prepare a myceliated high-protein food product with increased digestibility, decreased phytic acid component, decreased oryzacystatin, and/or increased polyphenol content, which includes culturing a fungi an aqueous media which has a high level of plant protein, for example at least 20 g protein per 100 g dry weight with excipients, on a dry weight basis. The plant protein can include pea, rice and/or chickpea. The fungi can include comprises Lentinula spp., Agaricus spp., Pleurotus spp., Boletus spp., or Laetiporus spp. After culturing, the material is harvested by obtaining the myceliated high-protein food product via drying or concentrating. The resultant myceliated high-protein food product may have its taste, flavor, or aroma modulated, such as by increasing desirable flavors or tastes such as meaty, savory, umami, popcorn and/or by decreasing undesirable flavors such as bitterness, astringency or beaniness. Deflavoring and/or deodorizing as compared to non-myceliated control materials can also be observed. Also disclosed are myceliated high-protein food products made by e.g. the methods of the invention. Foods such as textured protein, dairy analogs, crisps, and the like may include the high protein food products disclosed.

### CROSS-REFERENCE TO RELATED APPLICATIONS

This patent application claims the benefit of copending U.S. Provisional Patent Application No. 63/025,523, entitled “Methods for Increasing Digestibility of High Protein Food Compositions,” filed May 15, 2020; this patent also is a “continuation-in-part,” of copending U.S. Ser. No. 17/074,630, entitled “Methods for Production and Use of Myceliated High Protein Compositions,” filed Oct. 20, 2020, which in turn is a continuation of U.S. patent application Ser. No. 16/025,365, filed Jul. 2, 2018, entitled “Methods for the Production and Use of Myceliated High Protein Food Compositions,” now U.S. Pat. No. 10,806,101 which is a “continuation-in-part” of U.S. patent application Ser. No. 15/488,183, filed Apr. 14, 2017, entitled “Methods for the Production and Use of Myceliated High Protein Food Compositions,” now U.S. Pat. No. 10,010,103, which claims the benefit of U.S. Provisional Application No. 62/322,726, filed Apr. 14, 2016, entitled “Methods for the Production and Use of Myceliated High Protein Food Compositions” now expired, all of which are incorporated by reference in their entireties.

### BACKGROUND OF INVENTION

Plant-based protein food are emerging as alternative to animal derived protein. Several advantages make plant protein an ideal replacement to meat; however, two main drawbacks prevent their full acceptance in the food space. In general, the nutritional value of unprocessed single source plant protein for humans is often inferior to that of animal protein sources. By themselves, proteins derived from pea (Pisum sativum) and rice (Oryza sativa) are deficient in lysine, methionine and some branched chain amino acids, and are therefore considered of lower nutritional quality. However, if combined in correct proportions, pea protein and rice protein may complement each other to deliver a blend with an ideal balance of indispensable amino acids that is adequate for human nutrition. In 1991 the Food and Agriculture organization (FAO) and World Health Organization (WHO) introduced the Protein Digestibility Corrected Amino Acid Score PDCAAS). This concept is based on the assumption that a protein blend's nutritional value is determined not only by the amino acid profile, but also by the ability of the human gastrointestinal tract to hydrolyze individual proteins and by the rate at which free amino acids are absorbed into the blood stream. Although the PDCAAS score has been widely adopted to describe protein nutritional value, it is calculated from the total tract digestibility of crude protein (CP) and based on the assumption that all amino acids (AAs) in CP have the same digestibility. However, the digestibility of CP is not representative of the digestibility of all AAs because individual AAs are digested with different efficiencies. Moreover, fermentation of the free AAs by the lower intestine microbiome can affect fecal AA excretion and hence alter the PDCAAS values. Therefore, measuring digestibility at the distal ileum (the end of the small intestine) provides the most realistic estimate of AA bioavailability as compared to total tract digestibility. Based on these facts, in 2013 the FAO introduced the Digestible Indispensable Amino Acid Score (DIAAS) as a method to evaluate protein quality. Because DIAAS is calculated by measuring ileal digestibility of individual AAs, it more accurately describes the true nutritional value of dietary protein than the PDCAAS method. Additionally, DIAAS method provides a more precise assessment of protein quality for a blend of different dietary protein sources. Nonetheless, PDCAAS is still widely used in North America as measurement of protein quality.

Protein digestibility is also partially dependent on the solubility of the protein material and the presence of residual antinutrients such as protease inhibitors and phytic acid. Cereal grains and legumes contain several protease inhibitors of major concern. Particularly pea is rich in trypsin inhibitors while rice bran is known to contain considerable amounts of the oryzacystatin-I (OC-I), a rice cystatin (cysteine protease inhibitor) which binds tightly and reversibly to the papain-like group of cysteine proteinases. The removal/reduction of such compounds in plant protein concentrates remains highly desirable. In many cases antinutrients complex with proteins forming precipitates that are not easily accessible by gastric digestive enzymes. Phytic acid is the main storage of phosphorous in seeds of legumes and cereals. Due to its 6 phosphate groups, phytic acid acts as a powerful chelating agent, interfering with absorption of key minerals such as zinc, iron, magnesium and calcium in the gastrointestinal tract during digestion. Moreover, because phytate can sequester Ca⁺² and Mg⁺², co-factors of digestive proteases and α-amylases, it can indirectly impair digestion. A direct inhibitory effect of phytate on these enzymes has also been proposed. Therefore, the presence of phytate in protein concentrates has the potential of negatively impacting digestibility in several ways and consequently lowering the nutritional quality of plant proteins. Removal of phytates would greatly improve the nutritional value of foods and several methodologies are employed in the food industry to obtain this objective. Phytases, the enzymes responsible for hydrolyzing phytic acid into inositol and phosphate are widely distributed among microorganisms, including fungi such as shiitake.

The other main disadvantage of plant derived protein is their low organoleptic characteristics. Specifically, plant proteins often display off-flavors, which makes their incorporation into meat or dairy analog products challenging. For example, protein forms such as pea proteins are associated with beany aromas due to the presence of the volatiles 3-alkyl-2-methoxypyrazines (galbazine) and have bitter flavors associated with plant lipids and saponins.

Rice bran is known to contain considerable amounts of the oryzacystatin-I (OC-I), a rice cystatin (cysteine protease inhibitor) which binds tightly and reversibly to the papain-like group of cysteine proteinases. In many cases antinutrients complex with proteins, forming precipitates that are not easily accessible by gastric digestive enzymes.

There is therefore a need for efficient, high quality and low cost high-protein food sources with acceptable taste, flavor and/or aroma profiles, with increased digestibility and/or reduced antinutrients.

### SUMMARY OF THE INVENTION

In this work we describe the improvement of organoleptic characteristics, physical properties and the digestibility of a pea and rice protein concentrate blends through submerged fermentation with shiitake mycelium. GC-MS, GC-O and sensory analyses show a reduction of off-note compounds associated with the fermentation. Ileal digestion pig studies indicate a clear increase in digestibility of the fermented protein blend. We also describe increases in the solubility of the fermented blend and a reduction in the antinutrient phytate and antinutrient oryzacystatin.

The present inventors have found that culturing a fungus in a high protein media provides an economically viable product, and also found that such treatment can also alter the taste, flavor, physical properties, components, or aroma of high protein food compositions in unexpected ways. The process additionally enables the production of protein concentrates, isolates and high protein foodstuffs that have been imbued with mycelial material, thereby altering aspects of the media used in the production of products according to the methods of the present invention. The present invention also presents the ability to stack protein sources to optimize amino acid profiles of products made according to the methods of the invention.

Thus, the present invention includes methods to prepare a myceliated high-protein food product by culturing a fungus in an aqueous media which includes a high-protein material, with amounts of protein of at least 20 g protein per 100 g total dry weight with excipients, resulting in a myceliated high-protein food product, whereby the flavor or taste of the myceliated high-protein food product is modulated compared to the unfermented high-protein material; and/or wherein the amount of phytate and/or the amount of oryzacystatin have been reduced, compared to the unfermented high-protein material.

Appropriate fungi to use in the methods of the present invention include, for example, Lentinula spp., such as L. edodes, Agaricus spp., such as A. blazei, A. bisporus, A. campestris, A. subrufescens, A. brasiliensis, or A. silvaticus; Pleurotus spp., Boletus spp., or Laetiporus spp. In one embodiment, the fungi for the invention include fungi from optionally, liquid culture of species generally known as oyster, porcini, ‘chicken of the woods’ and shiitake mushrooms. These include Pleurotus (oyster) species such as Pleurotus ostreatus, Pleurotus salmoneostramineus (Pleurotus djamor), Pleurotus eryngii, or Pleurotus citrinopileatus; Boletus (porcini) species such as Boletus edulis; Laetiporus (chicken of the woods) species such as Laetiporus sulfureus, and many others such as L. budonii, L. miniatus, L. flos-musae, L. discolor; and Lentinula (shiitake) species such as L. edodes. Also included are Lepista nuda, Hericium erinaceus, Agaricus blazeii, and combinations thereof.

The amounts of protein in the aqueous media can be between 10 g/L protein and 500 g/L protein. The aqueous media may include a high-protein material, which is a protein concentrate or a protein isolate from a vegetarian or non-vegetarian source. The vegetarian source may include pea, rice, soy, cyanobacteria, grain, hemp, chia, chickpea, potato protein, algal protein and nettle protein or combinations of these. In embodiments, the vegetarian source is pea, rice, chickpea or a combination thereof. In embodiments, the vegetarian source is pea, chickpea or a combination thereof. In embodiments, the vegetarian source is rice, chickpea, or a combination thereof.

The produced myceliated high-protein food product may be pasteurized, sterilized, dried, powderized. The produced myceliated high-protein food product may have its flavors, tastes, and/or aromas enhanced, such as by increasing meaty flavors, enhancing umami taste, enhancing savory flavors, enhancing popcorn flavors, or enhancing mushroom flavors in the myceliated high-protein food product; or, the produced high-protein food product may have its flavors, tastes and/or aromas decreased, resulting in milder aromas or tastes, or reduced bitter, astringent, beany flavors, tastes, or aromas.

In embodiments, the aromas reduced include a reduced pea aroma, a reduced rice aroma, a reduced beany aroma, a reduced mushroom aroma, a reduced overripe vegetable aroma, or decreased cardboard-type aroma. In some embodiments, the myceliated high protein food product has increased mushroom aroma. In embodiments, a myceliated high protein food product that includes pea protein will have reduced pea aroma; or a myceliated high protein food product that includes rice protein will have reduced rice aroma. In embodiments, a myceliated high protein food product will have an increased mushroom aroma.

In embodiments, the flavors reduced include reduced pea flavor, reduced beany flavor, reduced rice flavor. In embodiments, the flavors increased include increased sour flavors, increased umami flavors, increased mushroom flavors.

The present invention also includes a myceliated high-protein food product made by, for example, the processes of the invention. The myceliated high-protein food product may be at least 20% protein, may be produced from a vegetarian source such as pea or rice, and may have enhanced desirable flavors and/or decreased undesirable

Without wishing to be bound by any particular theory, there may be discussion herein of beliefs or understandings of underlying principles relating to the devices and methods disclosed herein. It is recognized that regardless of the ultimate correctness of any mechanistic explanation or hypothesis, an embodiment of the invention can nonetheless be operative and useful.

### DETAILED DESCRIPTION OF THE INVENTION

In general, the terms and phrases used herein have their art-recognized meaning, which can be found by reference to standard texts, journal references and contexts known to those skilled in the art. The following definitions are provided to clarify their specific use in the context of the invention.

Plant proteins can perform as inexpensive and environmentally friendly meat-replacements. However, poor taste characteristics and relatively low nutritional value prevent their full acceptance as meat substitutes. Fermentation of food has been historically used to improve the quality of foods. In this work we describe the improvement in digestibility, nutritional value, physical properties, and organoleptic characteristics, of a pea and rice protein concentrate blend through fermentation with shiitake mushroom mycelium. Ileal digestibility pig studies show increases in the DIAAS for the shiitake fermented pea and rice protein blend turning into an “excellent source” of protein for humans. The fermentation also increases the solubility of the protein blend and reduces the content of the antinutrient compounds phytates and protease inhibitor. Mass spectrometry and sensory analyses of fermented protein blend indicates that fermentation leads to a reduction in off-note compounds substantially improving the organoleptic performance.

In one embodiment, the present invention includes a method to prepare a myceliated high-protein food product. The method may optionally include the steps of providing an aqueous media comprising a high-protein material. The aqueous media may comprise, consist of, or consist essentially of at least 20 g protein per 100 g total excipients, on a dry weight basis. The media may also comprise, consist of or consist essentially of optional additional excipients as identified hereinbelow. The aqueous media may be inoculated with a fungal culture. The inoculated media may then be cultured to produce a myceliated high-protein food product, and the myceliated high-protein food product taste, flavor, and/or aroma may be modulated and/or the myceliated high-protein food product has increased digestibility as measured by the Digestible Indispensable Amino Acid Score (DIAAS); and/or reduced phytic acid component; and/or reduced oryzacystatin component compared to the high-protein material in the absence of the culturing step.

The aqueous media may comprise, consist of, or consist essentially of a high-protein material. The high-protein material to include in the aqueous media can be obtained from a number of sources, including vegetarian sources (e.g., plant sources) as well as non-vegetarian sources, and can include a protein concentrate and/or isolate. Vegetarian sources include meal, protein concentrates and isolates prepared from a vegetarian source such as pea, rice, chickpea, soy, cyanobacteria, hemp, chia and other sources, or a combination thereof. For example, cyanobacteria containing more than 50% protein can also be used a source of high-protein material. Typically, a protein concentrate is made by removing the oil and most of the soluble sugars from a meal, such as soybean meal. Such a protein concentrate may still contain a significant portion of non-protein material, such as fiber. Typically, protein concentrations in such products are between 55-90%. The process for production of a protein isolate typically removes most of the non-protein material such as fiber and may contain up to about 90-99% protein. A typical protein isolate is typically subsequently dried and is available in a powdered form and may alternatively be called “protein powder.”

Non-vegetarian sources for the high-protein material may also be used in the present invention. Such non-vegetarian sources include whey, casein, egg, meat (beef, chicken, pork sources, for example), isolates, concentrates, broths, or powders. However, in some embodiments vegetarian sources have certain advantages over non-vegetarian sources. For example, whey or casein protein isolates generally contain some amount of lactose and which can cause difficulties for those who are lactose-intolerant. Egg protein isolates may cause problems to those who are allergic to eggs and are is also quite expensive. Certain vegetable sources have disadvantages as well, while soy protein isolates have good Protein Digestibility Corrected Amino Acid Scores (PDCAAS) and digestible indispensable amino acid scores (DIAAS) scores, and is inexpensive, soy may be allergenic and has some consumer resistance due to concerns over phytoestrogens and taste. Rice protein is highly digestible, but is deficient in some amino acids such as lysine. Rice protein is therefore not a complete protein and further many people perceive rice protein to have an off-putting taste and aroma. Pea protein is generally considered to contain all essential amino acids, is not balanced and thus is not complete and many people perceive pea protein to have an off-putting aroma. Hemp protein is a complete protein with decent taste and aroma, but is expensive.

In one embodiment, mixtures of any of the high-protein materials disclosed can be used to provide, for example, favorable qualities, such as a more complete (in terms of amino acid composition) high-protein material. In one embodiment, high-protein materials such as pea protein and rice protein can be combined. In one embodiment, the ratio of a mixture can be from 1:10 to 10:1 pea protein:rice protein (on a dry basis). In one embodiment, the ratios can optionally be 5:1 to 1:5, 2:1 to 1:2, or in one embodiment, 1:1.

The high-protein material itself can be about 20% protein, 30% protein, 40% protein, 45% protein, 50% protein, 55% protein, 60% protein, 65% protein, 70% protein, 75% protein, 80% protein, 85% protein, 90% protein, 95% protein, or 98% protein, or at least about 20% protein, at least about 30% protein, at least about 40% protein, at least about 45% protein, at least about 50% protein, at least about 55% protein, at least about 60% protein, at least about 65% protein, at least about 70% protein, at least about 75% protein, at least about 80% protein, at least about 85% protein, at least about 90% protein, at least about 95% protein, or at least about 98% protein.

This invention discloses the use of concentrated media, which provides, for example, an economically viable economic process for production of an acceptably tasting and/or flavored high-protein food product. In one embodiment of the invention the total media concentration is up to 150 g/L but can also be performed at lower levels, such as 5 g/L. Higher concentrations in media result in a thicker and/or more viscous media, and therefore are optionally processed by methods known in the art to avoid engineering issues during culturing or fermentation. To maximize economic benefits, a greater amount of high-protein material per L media is used. The amount is used is chosen to maximize the amount of high-protein material that is cultured, while minimizing technical difficulties in processing that may arise during culturing such as viscosity, foaming and the like. The amount to use can be determined by one of skill in the art, and will vary depending on the method of fermentation

The amount of total protein in the aqueous media may comprise, consist of, or consist essentially of at least 20 g, 25 g, 30 g, 35 g, 40 g, 45 g, 50 g, 55 g, 60 g, 65 g, 70 g, 75 g, 80 g, 85 g, 90 g, 95 g, or 100 g, or more, of protein per 100 g total dry weight with excipients, or per total all components on a dry weight basis. Alternatively, the amount of protein comprise, consist of, or consist essentially of between 20 g to 90 g, between 30 g and 80 g, between 40 g and 70 g, between 50 g and 60 g, of protein per 100 g dry weight with excipients.

In some embodiments, the total protein in aqueous media is about 45 g to about 100 g, or about 80-100 g of protein per 100 g dry weight with excipients.

In another embodiment, the aqueous media comprises between about 1 g/L and 200 g/L, between about 5 g/L and 180 g/L, between about 20 g/L and 150 g/L, between about 25 g/L and about 140 g/L, between about 30 g/L and about 130 g/L, between about 35 g/L and about 120 g/L, between about 40 g/L and about 110 g/L, between about 45 g/L and about 105 g/L, between about 50 g/L and about 100 g/L, between about 55 g/L and about 90 g/L, or about 75 g/L protein; or between about 50 g/L-150 g/L, or about 75 g/L and about 120 g/L, or about 85 g/L and about 100 g/L. Alternatively, the aqueous media comprises at least about 10 g/L, at least about 15 g/L, at least about 20 g/L, at least about 25 g/L, at least about 30 g/L, at least about 35 g/L, at least about 40 g/L or at least about 45 g/L protein. In fermenters, in some embodiments the amount to use includes between about 1 g/L and 150 g/L, between about 10 g/L and 140 g/L, between about 20 g/L and 130 g/L, between about 30 g/L and about 120 g/L, between about 40 g/L and about 110 g/L, between about 50 g/L and about 100 g/L, between about 60 g/L and about 90 g/L, between about 70 g/L and about 80 g/L, or at least about 20 g/L, at least about 30 g/L, at least about 40 g/L, at least about 50 g/L, at least about 60 g/L, at least about 70 g/L, at least about 80 g/L, at least about 90 g/L, at least about 100 g/L, at least about 110 g/L, at least about 120 g/L, at least about 130 g/L or at least about 140 g/L.

In some embodiments, the aqueous media comprises between about 50 g/L and about 100 g/L, or about 80 g/L, about 85 g/L, about 90 g/L, about 95 g/L about 100 g/L, about 110 g/L, about 120 g/L, about 130 g/L, about 140 g/L, or about 150 g/L.

It can be appreciated that in calculating such percentages, the percentage of protein in the high-protein material must accounted for. For example, if the amount of high-protein material is 10 g, and the high-protein material is 80% protein, then the protein source includes 8 g protein and 2 non-protein material. When added to 10 g of excipients to create 20 total grams dry weight with excipients, then the total is 8 g protein per 20 g total excipients, or 40% protein, or 40 g protein per 100 g total protein plus excipients. If a protein-containing excipient such as yeast extract or peptone is added to the media, the amount of protein per g total weight plus excipients will be slightly higher, taking into account the percentage of protein and the amount added of the protein-containing excipient, and performing the calculation as discussed herein, as is known in the art.

In some embodiments, the high-protein material, after preparing the aqueous media of the invention, is not completely dissolved in the aqueous media. Instead, the high-protein material may be partially dissolved, and/or partially suspended, and/or partially colloidal. However, even in the absence of complete dissolution of the high-protein material, positive changes may be affected during culturing of the high-protein material. In one embodiment, the high-protein material in the aqueous media is kept as homogenous as possible during culturing, such as by ensuring agitation and/or shaking.

In one embodiment, the aqueous media further comprises, consists of, or consists essentially of materials other than the high-protein material, e.g., excipients as defined herein and/or in particular embodiments. Excipients can comprise any other components known in the art to potentiate and/or support fungal growth, and can include, for example, nutrients, such as proteins/peptides, amino acids as known in the art and extracts, such as malt extracts, meat broths, peptones, yeast extracts and the like; energy sources known in the art, such as carbohydrates; essential metals and minerals as known in the art, which includes, for example, calcium, magnesium, iron, trace metals, phosphates, sulphates; buffering agents as known in the art, such as phosphates, acetates, and optionally pH indicators (phenol red, for example). Excipients may include carbohydrates and/or sources of carbohydrates added to media at 5-10 g/L. It is usual to add pH indicators to such formulations.

Excipients may also include peptones/proteins/peptides, as is known in the art. These are usually added as a mixture of protein hydrolysate (peptone) and meat infusion, however, as used in the art, these ingredients are typically included at levels that result in much lower levels of protein in the media than is disclosed herein. Many media have, for example, between 1% and 5% peptone content, and between 0.1 and 5% yeast extract and the like.

In one embodiment, excipients include for example, yeast extract, malt extract, maltodextrin, peptones, and salts such as diammonium phosphate and magnesium sulfate, as well as other defined and undefined components such as potato or carrot powder. In some embodiments, organic (as determined according to the specification put forth by the National Organic Program as penned by the USDA) forms of these components may be used.

In one embodiment, excipients comprise, consist of, or consist essentially of dry carrot powder, dry malt extract, diammonium phosphate, magnesium sulfate, and citric acid. In one embodiment, excipients comprise, consist of, or consist essentially of dry carrot powder between 0.1-10 g/L, dry malt extract between 0.1 and 20 g/L, diammonium phosphate between 0.1 and 10 g/L, and magnesium sulfate between 0.1 and 10 g/L. Excipients may also optionally comprise, consist of, or consist essentially of citric acid and an anti-foam component. The anti-foam component can any anti-foam component known in the art, such as a food-grade silicone anti-foam emulsion or an organic polymer anti-foam (such as a polypropylene-based polyether composition).

In another embodiment, the medium comprises, consists of or consists essentially of the high protein material as defined herein and an anti-foam component, without any other excipients present.

The method may also comprise the optional step of sterilizing the aqueous media prior to inoculation by methods known in the art, including steam sterilization and all other known methods to allow for sterile procedure to be followed throughout the inoculation and culturing steps to enable culturing and myceliation by pure fungal strains. Alternatively, the components of the media may be separately sterilized and the media may be prepared according to sterile procedure.

The method also includes inoculating the media with a fungal culture. The fungal culture may be prepared by culturing by any methods known in the art. In one embodiment, the methods to culture may be found in, e.g., PCT/US14/29989, filed Mar. 15, 2014, PCT/US14/29998, filed Mar. 15, 2014, all of which are incorporated by reference herein in their entireties.

The fungal cultures, prior to the inoculation step, may be propagated and maintained as is known in the art. In one embodiment, the fungi discussed herein can be kept on 2-3% (v/v) mango puree with 3-4% agar (m/v). Such media is typically prepared in 21.6 L handled glass jars being filled with 1.4-1.5 L media. Such a container pours for 50-60 90 mm Petri plates. The media is first sterilized by methods known in the art, typically with an autoclave. Conventional B. stearothermophilus and thermocouple methods are used to verify sterilization parameters. Some strains, such as L. sulfureus, grow better when supplemented with 1% yellow cornmeal. Agar media can also be composed of high-protein material to sensitize the strain to the final culture. This technique may also be involved in strain selection of the organisms discussed herein. Agar media should be poured when it has cooled to the point where it can be touched by hand (˜40-50° C.).

In one embodiment, maintaining and propagating fungi for use for inoculating the high-protein material as disclosed in the present invention may be carried out as follows. For example, a propagation scheme that can be used to continuously produce material according to the methods is discussed herein. Once inoculated with master culture and subsequently colonized, Petri plate cultures can be used at any point to propagate mycelium into prepared liquid media. As such, plates can be propagated at any point during log phase or stationary phase but are encouraged to be used within three months and in another embodiment within 2 years, though if properly handled by those skilled in the art can generally be stored for as long as 10 years at 4° C. and up to 6 years at room temperature.

In some embodiments, liquid cultures used to maintain and propagate fungi for use for inoculating the high-protein material as disclosed in the present invention include undefined agricultural media with optional supplements as a motif to prepare culture for the purposes of inoculating solid-state material or larger volumes of liquid. In some embodiments, liquid media preparations are made as disclosed herein. Liquid media can be also sterilized and cooled similarly to agar media. Like agar media it can theoretically be inoculated with any fungal culture so long as it is deliberate and not contaminated with any undesirable organisms (fungi inoculated with diazotrophs may be desirable for the method of the present invention). As such, liquid media are typically inoculated with agar, liquid and other forms of culture. Bioreactors provide the ability to monitor and control aeration, foam, temperature, and pH and other parameters of the culture and as such enables shorter myceliation times and the opportunity to make more concentrated media.

In one embodiment, the fungi for use for inoculating the high-protein material as disclosed in the present invention may be prepared as a submerged liquid culture and agitated on a shaker table, or may be prepared in a shaker flask, by methods known in the art and according to media recipes disclosed in the present invention. The fungal component for use in inoculating the aqueous media of the present invention may be made by any method known in the art. In one embodiment, the fungal component may be prepared from a glycerol stock, by a simple propagation motif of Petri plate culture to 0.5-4 L Erlenmeyer shake flask to 50% glycerol stock. Petri plates can comprise agar in 10-35 g/L in addition to various media components. Conducted in sterile operation, chosen Petri plates growing anywhere from 1-˜3,652 days can be propagated into 0.5-4 L Erlenmeyer flasks (or 250 to 1,000 mL Wheaton jars, or any suitable glassware) for incubation on a shaker table or stationary incubation. The smaller the container, the faster the shaker should be. In one embodiment, the shaking is anywhere from 40-160 RPM depending on container size and, with about a 1″ swing radius.

The culturing step of the present invention may be performed by methods (such as sterile procedure) known in the art and disclosed herein and may be carried out in a fermenter, shake flask, bioreactor, or other methods. In a shake flask, in one embodiment, the agitation rate is 50 to 240 RPM, or 85 to 95 RPM, and incubated for 1 to 90 days. In another embodiment the incubation temperature is 70-90° F. In another embodiment the incubation temperature is 87-89° F. Liquid-state fermentation agitation and swirling techniques as known in the art are also employed which include mechanical shearing using magnetic stir bars, stainless steel impellers, injection of sterile high-pressure air, the use of shaker tables and other methods such as lighting regimen, batch feeding or chemostatic culturing, as known in the art.

In one embodiment, culturing step is carried out in a bioreactor which is ideally constructed with a torispherical dome, cylindrical body, and spherical cap base, jacketed about the body, equipped with a magnetic drive mixer, and ports to provide access for equipment comprising DO, pH, temperature, level and conductivity meters as is known in the art. Any vessel capable of executing the methods of the present invention may be used. In another embodiment the set-up provides 0.1-5.0 ACH. Other engineering schemes known to those skilled in the art may also be used.

The reactor can be outfitted to be filled with water. The water supply system is ideally water for injection (WFI) system, with a sterilizable line between the still and the reactor, though RO or any potable water source may be used so long as the water is sterile. In one embodiment the entire media is sterilized in situ while in another embodiment concentrated media is sterilized and diluted into a vessel filled water that was filter and/or heat sterilized, or sufficiently treated so that it doesn't encourage contamination over the colonizing fungus. In another embodiment, high temperature high pressure sterilizations are fast enough to be not detrimental to the media. In one embodiment the entire media is sterilized in continuous mode by applying high temperature between 130° and 150° C. for a residence time of 1 to 15 minutes. Once prepared with a working volume of sterile media, the tank can be mildly agitated and inoculated. Either as a concentrate or whole media volume in situ, the media can be heat sterilized by steaming either the jacket, chamber or both while the media is optionally agitated. The medium may optionally be pasteurized instead.

In one embodiment, the reactor is used at a large volume, such as in 500,000-200,000 L working volume bioreactors. When preparing material at such volumes the culture must pass through a successive series of larger bioreactors, any bioreactor being inoculated at 0.5-15% of the working volume according to the parameters of the seed train. A typical process would pass a culture from master culture, to Petri plates, to flasks, to seed bioreactors to the final main bioreactor when scaling the method of the present invention. To reach large volumes, 3-4 seeds may be used. The media of the seed can be the same or different as the media in the main. In one embodiment, the fungal culture for the seed is a protein concentration as defined herein, to assist the fungal culture in adapting to high-protein media in preparation for the main fermentation. Such techniques are discussed somewhat in the examples below. In one embodiment, foaming is minimized by use of anti-foam on the order of 0.5 to 2.5 g/L of media, such as those known in the art, including insoluble oils, polydimethylsiloxanes and other silicones, certain alcohols, stearates and glycols. In one embodiment, lowering pH assists in culture growth, for example, for L. edodes pH may be adjusted by use of citric acid or by any other compound known in the art, but care must be taken to avoid a sour taste for the myceliated high-protein product. The pH may be adjusted to between about 4.5 and 5.5, for example, to assist in growth.

In one embodiment, during the myceliation step, for example, wherein the media comprises at least 50% (w/w) protein on a dry weight basis, and/or wherein the media comprises at least 50 g/L protein, the pH does not change during processing. “pH does not change during processing” is understood to mean that the pH does not change in any significant way, taking into account variations in measured pH which are due to instrument variations and/or error. For example, the pH will stay within about plus or minus 0.3 pH units, plus or minus 0.25 pH units, plus or minus 0.2 pH units, plus or minus 0.15 pH units, or plus or minus 0.1 pH units of a starting pH of the culture during the myceliation, e.g. processing step. Minor changes in pH are also contemplated during processing, particularly in media which do not contain an exogenous buffer such as diammonium phosphate. A minor change in pH can be defined as a pH change of plus or minus 0.5 pH units or less, plus or minus 0.4 pH units or less, plus or minus 0.3 pH units or less, plus or minus 0.25 pH units or less, plus or minus 0.2 pH units or less, plus or minus 0.15 pH units or less, or plus or minus 0.1 pH units or less of a starting pH.

In one embodiment, a 1:1 mixture of pea protein and rice protein at 40% protein (8 g per 20 g total plus excipients) media was prepared, and an increase in biomass concentration was correlated with a drop in pH. After shaking for 1 to 10 days, an aliquot (e.g. 10 to 500 mL) of the shake flask may be transferred in using sterile procedure into a sterile, prepared sealed container (such as a customized stainless steel can or appropriate conical tube), which can then adjusted with about 5-60%, sterile, room temperature (v/v) glycerol. The glycerol stocks can may be sealed with a water tight seal and can be held stored at −20° C. for storage. The freezer is ideally a constant temperature freezer. Glycerol stocks stored at 4° C. may also be used. Agar cultures can be used as inoculant for the methods of the present invention, as can any culture propagation technique known in the art.

It was found that not all fungi are capable of growing in media as described herein. Fungi useful for the present invention are from the higher order Basidio- and Ascomycetes. In some embodiments, fungi effective for use in the present invention include, but are not limited to, Lentinula spp., such as L. edodes, Agaricus spp., such as A. blazei, A. bisporus, A. campestris, A. subrufescens, A. brasiliensis, or A. silvaticus; Pleurotus spp., Boletus spp., or Laetiporus spp. In one embodiment, the fungi for the invention include fungi from optionally, liquid culture of species generally known as oyster, porcini, ‘chicken of the woods’ and shiitake mushrooms. These include Pleurotus (oyster) species such as Pleurotus ostreatus, Pleurotus salmoneostramineus (Pleurotus djamor), Pleurotus eryngii, or Pleurotus citrinopileatus; Boletus (porcini) species such as Boletus edulis; Laetiporus (chicken of the woods) species such as Laetiporus sulfureus, and many others such as L. budonii, L. miniatus, L. flos-musae, L. discolor; and Lentinula (shiitake) species such as L. edodes. Also included are Lepista nuda, Hericium erinaceus, Agaricus blazeii, and combinations thereof. In one embodiment, the fungi is Lentinula edodes. Fungi may be obtained commercially, for example, from the Penn State Mushroom Culture Collection. Strains are typically received as “master culture” PDY slants in 50 mL test tubes and are stored at all, but for A. blazeii, stored at 4° C. until plated. For plating, small pieces of culture are typically transferred into sterile shake flasks (e.g. 250 mL) so as not to contaminate the flask filled with a sterilized media (liquid media recipes are discussed below). Inoculated flasks shake for approximately ten hours and aliquots of said flasks are then plated onto prepared Petri plates of a sterile agar media. One flask can be used to prepare dozens to potentially hundreds of Petri plate cultures. There are other methods of propagating master culture though the inventors find these methods as disclosed to be simple and efficient.

Determining when to end the culturing step and to harvest the myceliated high-protein food product, which according to the present invention, to result in a myceliated high-protein food product with acceptable taste, flavor and/or aroma profiles, can be determined in accordance with any one of a number of factors as defined herein, such as, for example, visual inspection of mycelia, microscope inspection of mycelia, pH changes, changes in dissolved oxygen content, changes in protein content, amount of biomass produced, and/or assessment of taste profile, flavor profile, or aroma profile. In one embodiment, harvest can be determined by tracking protein content during culturing and harvest before significant catabolism of protein occurs. The present inventors found that protein catabolism can initiate in bioreactors at 30-50 hours of culturing under conditions defined herein. In another embodiment, production of a certain amount of biomass may be the criteria used for harvest. For example, biomass may be measured by filtering, such through a filter of 10-1000 μm, and has a protein concentration between between 0.1 and 25 g/L; or in one embodiment, about 0.2-0.4 g/L. In one embodiment, harvest can occur when the dissolved oxygen reaches about 10% to about 90% dissolved oxygen, or less than about 80% of the starting dissolved oxygen. Additionally, mycelial products may be measured as a proxy for mycelial growth, such as, total reducing sugars (usually a 40-95% reduction), β-glucan and/or chitin formation; harvest is indicated at 10²-10⁴ ppm. Other indicators include small molecule metabolite production depending on the strain (e.g. eritadenine on the order of 0.1-20 ppm for L. edodes or erinacine on the order of 0.1-1,000 ppm for H. erinaceus) or nitrogen utilization (monitoring through the use of any nitrogenous salts or protein, cultures may be stopped just as protein starts to get utilized or may continue to culture to enhance the presence of mycelial metabolites). In one embodiment, the total protein yield in the myceliated high-protein food product after the culturing step is about 75% to about 95%.

Harvest includes obtaining the myceliated high-protein food product which is the result of the myceliation step. After harvest, cultures can be processed according to a variety of methods. In one embodiment, the myceliated high-protein food product is pasteurized or sterilized. In one embodiment, the myceliated high-protein food product is dried according to methods as known in the art. Additionally, concentrates and isolates of the material may be prepared using variety of solvents or other processing techniques known in the art. In one embodiment the material is pasteurized or sterilized, dried and powdered by methods known in the art. Drying can be done in a desiccator, vacuum dryer, conical dryer, spray dryer, fluid bed or any method known in the art. Preferably, methods are chosen that yield a dried myeliated high-protein product (e.g., a powder) with the greatest digestibility and bioavailability. The dried myeliated high-protein product can be optionally blended, pestled milled or pulverized, or other methods as known in the art.

In many cases, the flavor, taste and/or aroma of high-protein materials as disclosed herein, such as protein concentrates or isolates from vegetarian or nonvegetarian sources (e.g. egg, whey, casein, beef, soy, rice, hemp, pea, chickpea, soy, cyanobacteria, and chia) may have flavors, which are often perceived as unpleasant, having pungent aromas and bitter or astringent tastes. These undesirable flavors and tastes are associated with their source(s) and/or their processing, and these flavors or tastes can be difficult or impossible to mask or disguise with other flavoring agents. The present invention, as explained in more detail below, works to modulate these tastes and/or flavors.

In one embodiment of the invention, flavors and/or tastes of the myceliated high-protein food product or products are modulated as compared to the high-protein material (starting material). In some embodiments, both the sterilization and myceliation contribute to the modulation of the resultant myceliated high-protein food products' taste.

In one embodiment, the aromas of the resultant myceliated high-protein food products prepared according to the invention are reduced and/or improved as compared to the high-protein material (starting material). In other words, undesired aromas are reduced and/or desired aromas are increased. In another embodiment, flavors and/or tastes may be reduced and/or improved. For example, desirable flavors and/or tastes may be increased or added to the high-protein material by the processes of the invention, resulting in myceliated high-protein food products that have added mushroom, meaty, umami, popcorn, buttery, and/or other flavors or tastes to the food product. The increase in desirable flavors and/or tastes may be rated as an increase of 1 or more out of a scale of 5 (1 being no taste, 5 being a very strong taste.)

Flavors and/or tastes of myceliated high-protein food products may also be improved by processes of the current invention. For example, deflavoring can be achieved, resulting in a milder flavor and/or with the reduction of, for example, bitter and/or astringent tastes and/or beany and/or weedy and/or grassy tastes. The decrease in undesirable flavors and/or tastes as disclosed herein may be rated as an decrease of 1 or more out of a scale of 5 (1 being no taste, 5 being a very strong taste.)

Culturing times and/or conditions can be adjusted to achieve the desired aroma, flavor and/or taste outcomes. For example, cultures grown for approximately 2-3 days can yield a deflavored product whereas cultures grown for longer may develop various aromas that can change/intensify as the culture grows. As compared to the control and/or high-protein material, and/or the pasteurized, dried and powdered medium not subjected to sterilization or myceliation, the resulting myceliated high-protein food product in some embodiments is less bitter and has a more mild, less beany aroma.

In one embodiment of the present invention, the myceliated high-protein food products made by the methods of the invention have a complete amino acid profile (all amino acids in the required daily amount) because of the media from which it was made has such a profile. While amino acid and amino acid profile transformations are possible according to the methods of the present invention, many of the products made according to the methods of the present invention conserve the amino acid profile while at the same time, more often altering the molecular weight distribution of the proteome.

In one embodiment, when grown in a rice and pea protein concentrate medium the oyster fungi (Pleurotus ostreatus) can convey a strong savory aroma that leaves after a few seconds at which point a mushroom flavor is noticeable. In one embodiment, the strains convey a savory meaty aroma and/or umami, savory or meaty flavor and/or taste. L. edodes and A. blazeii in some embodiments are effective at deflavoring with shorter culturing times, such as 1.5-8 days, depending on whether the culture is in a shake flask or bioreactor. L. edodes to particularly good for the deflavoring of pea and rice protein concentrate mixtures.

In one embodiment of the instant invention, a gluten isolate or concentrate can be mixed into a solution with excipients as disclosed herein in aqueous solution. In one embodiment, the gluten content of the medium is >10% (10-100%) on a dry weight basis and sterilized by methods known in the art for inoculation by any method known in the art with any fungi disclosed herein, for example, with L. sulfureus. It has been found that L. sulfureus produces large amounts of guanosine monophosphate (GMP) (20-40 g/L) and gluten hydrolysate, and it is theorized that the process of culturing will result in lowering measurable gluten content, such as below 20 ppm gluten on a dry weight basis according to ELISA assay. Without being bound by theory, it is believed that the cultured material, by action of production of GMP and gluten hydrolysate, act synergistically to produce umami flavor. Without being bound by theory, it is believed that the combination of GMP and gluten hydrolysate amplifies the umami intensity in some kind of multiplicative as opposed to additive manner. The culture can be processed by any of methods disclosed in the invention and as are known in the art to produce a product of potent umami taste. Gluten may be obtained from any source known in the art, such as corn, wheat and the like, and may be used as a concentrate or isolate from a source.

In embodiments, the methods of the present invention result in an increase in Digestible Indispensable Amino Acid Score (DIAAS) for a myceliated high-protein material that is at least 10% relative to high-protein material that is not myceliated. In embodiments, the increase is at least 5%, at least 10%, at least 15%, at least 20%, or at least 25%. Measurement of DIAAS can be made by any methods known in the art, and refers to the ileal digestibility (end of the small intestine) because amino acids are absorbed only from the small intestine and fermentation in the large intestine from intestinal microbiota can affect (decrease) fecal excretion. Ileal digestibility is a more accurate estimate of amino acid bioavailability than total tract digestibility in humans and pigs. Additionally, the digestibility of crude protein is not representative of the digestibility of all amino acids, because individual amino acids are digested with different efficiencies. In one embodiment, the DIAAS score is obtained using art-known methods via a pig study. In another embodiment, the DIAAS score may be obtained using art-known methods via a rat study. The invention also includes myceliated high-protein material with an increase in DIAAS as described herein.

In embodiments, the methods of the invention and/or the products produced by the invention result in a decrease of phytic acid for a myceliated high-protein material that is at least 40% relative to high-protein material that is not myceliated. In embodiments, the decrease is at least 20%, at least 30%, at least 40%, or at least 50%. As is known in the art, the presence of residual phytate in plant protein can decrease protein digestibility. Reduction in observed phytate levels may be related to the increase in digestibility noted.

In embodiments, the methods of the invention and/or the products produced by the invention result in a decrease of oryzacystatin for a myceliated high protein material that is at least 50% relative to high protein material that is not myceliated. In embodiments, the decrease is at least 20%, at least 40%, at least 50%, at least 60%, at least 80%, or at least 90%. As known in the art, the presence of residual oryzacystatin in plant protein can decrease protein digestibility. Reduction in observed oryzacystatin may be related to the increase in digestibility noted.

In embodiments, the methods of the invention result in a increase in polyphenols for a myceliated high-protein material that is at least 40% relative to high-protein material that is not myceliated. In embodiments, the increase is at least 20%, at least 30%, at least 40%, or at least 50%. Polyphenols (also known as polyhydroxyphenols) are a structural class of natural organic chemicals characterized by the presence of large multiples of phenol structural units. The number and characteristics of these phenol structures underlie the unique physical, chemical, and biological (metabolic, toxic, therapeutic, etc.) properties of particular members of the class. Many foods in a healthy diet contain high levels of naturally occurring phenols in fruits, vegetables, cereals, tea and coffee. Fruits like grapes, apple, pear, cherries and berries contain up to 200-300 mg polyphenols per 100 grams fresh weight. The products manufactured from these fruits also contain polyphenols in significant amounts. Typically a glass of red wine or a cup of tea or coffee contains about 100 mg polyphenols. Mushrooms and mycelia have significant amounts of polyphenols. Polyphenols are thought to be beneficial in the diet as they can support normal functioning of, improve or help treat digestion issues, weight management difficulties, diabetes, neurodegenerative disease, and cardiovascular diseases.

The present invention also includes a myceliated food product made by any of the methods of as disclosed herein. An embodiment of the invention includes a composition comprising a myceliated high-protein food product, wherein the myceliated high-protein food product is at least 50% (w/w) protein on a dry weight basis, wherein the myceliated high protein food product is derived from a plant source, wherein the myceliated high protein product is myceliated by a fungal culture comprising Lentinula edodes, Agaricus blazeii, Pleurotus spp., Boletus spp., or Laetiporus spp. in a media comprising at least 50 g/L protein, and wherein the myceliated high protein food product has increased digestibility as measured by the Digestible Indispensable Amino Acid Score (DIAAS); and/or reduced phytic acid component; and/or reduced oryzacystatin component; and/or reduced undesirable flavors and/or reduced undesirable aromas; as compared to the high-protein material that is not myceliated compared with a non-myceliated food product.

The present invention also comprises a myceliated high-protein food product as defined herein. The myceliated high-protein food product can comprise, consist of, or consist essentially of at least 20%, at least 25%, at least 30%, at least 35%, at least 40%, at least 45%, at least 50%, at least 55%, at least 60%, at least 65%, at least 70%, at least 75%, at least 80%, at least 85%, at least 90%, or at least 95%, protein.

“Myceliated” as used herein, means a high-protein material as defined herein having been cultured with live fungi as defined herein and achieved at least 0%, at least a 5%, at least a 10%, at least a 20%, at least a 30%, at least a 40%, at least a 50%, at least a 60%, at least a 70%, at least a 80%, at least a 90%, at least a 100%, at least a 120%, at least a 140%, at least a 160%, at least a 180%, at least a 200%, at least a 250%, at least a 300%, at least a 400%, at least a 500% increase in biomass or more, to result in a myceliated high-protein food product.

In some embodiments, the high-protein material is a protein concentrate or a protein isolate, which may be obtained from vegetarian or nonvegetarian source as defined herein, including pea, rice, soy, or combinations thereof. In some embodiments, the myceliated high-protein food product can be myceliated by a fungal culture as defined herein. In some embodiments, the myceliated high-protein food product can have enhanced meaty, savory, umami, popcorn, and/or mushroom flavors, aromas and/or tastes as compared to the high-protein material. In other embodiments, the myceliated high-protein food product has decreased flavors, tastes and/or aromas (deflavoring) leading to a milder and/or an improved flavor, taste or aroma. In one embodiment reduced bitterness, astringency and/or beany, grassy or weedy tastes are observed.

Such prepared myceliated high-protein food products can be used to create a number of food compositions, including, without limitation, using art-known methods, can be used to create a number of new food compositions, including, without limitation, reaction flavors, dairy alternative products, ready to mix beverages and beverage bases; extruded and extruded/puffed products; textured products such as meat analogs; sheeted baked goods; meat analogs and extenders; bar products and granola products; baked goods and baking mixes; granola; and soups/soup bases. The methods to prepare a food composition can include the additional, optional steps of cooking, extruding, and/or puffing the food composition according to methods known in the art to form the food compositions comprising the myceliated high protein food product of the invention. The invention includes methods to make food compositions, comprising providing a myceliated high protein food product of the invention, providing an edible material, and mixing the myceliated high protein food product of the invention and the edible material. The edible material can be, without limitation, a starch, a flour, a grain, a lipid, a colorant, a flavorant, an emulsifier, a sweetener, a vitamin, a mineral, a spice, a fiber, a protein powder, nutraceuticals, sterols, isoflavones, lignans, glucosamine, an herbal extract, xanthan, a gum, a hydrocolloid, a starch, a preservative, a legume product, a food particulate, and combinations thereof. A food particulate can include cereal grains, cereal flakes, crisped rice, puffed rice, oats, crisped oats, granola, wheat cereals, protein nuggets, texturized plant protein ingredients, flavored nuggets, cookie pieces, cracker pieces, pretzel pieces, crisps, soy grits, nuts, fruit pieces, corn cereals, seeds, popcorn, yogurt pieces, and combinations of any thereof.

The methods to prepare a food composition can include the additional, optional steps of cooking, extruding, and/or puffing the food composition according to methods known in the art to form the food compositions comprising the myceliated high protein food product of the invention.

In one embodiment, the food composition can include an alternative dairy product comprising a myceliated high protein food product according to the invention. An alternative dairy product according to the invention includes, without limitation, products such as analog skimmed milk, analog whole milk, analog cream, analog fermented milk product, analog cheese, analog yogurt, analog butter, analog dairy spread, analog butter milk, analog acidified milk drink, analog sour cream, analog ice cream, analog flavored milk drink, or an analog dessert product based on milk components such as custard. Methods for producing alternative dairy products using alternative proteins, such as plant-based proteins as disclosed herein including nuts (almond, cashew), seeds (hemp), legumes (pea), rice, and soy are known in the art. These known methods for producing alternative dairy products using a plant-based protein can be adapted to use with a myceliated high protein food product using art-known techniques.

An alternative dairy product according to the invention may additionally comprise non-milk components, such as oil, protein, carbohydrates, and mixtures thereof. Dairy products may also comprise further additives such as enzymes, flavoring agents, microbial cultures, salts, thickeners, sweeteners, sugars, acids, fruit, fruit juices, any other component known in the art as a component of, or additive to a dairy product, and mixtures thereof.

The present invention can also include beverages and beverage bases comprising a myceliated high protein food product according to the invention which can be used as non-dairy-based meal replacement beverages. A myceliated high protein food product according to the invention may be used to prepare a meal replacement beverage that is optionally non-dairy-based. Methods for creating vegan meal replacement beverages using soybeans as the protein source are known in the art and protein source may simply be substituted with myceliated high protein food product protein of the invention, for example. For example, a typical meal replacement drink would include, per 243 ml serving, a total of 4 g carbohydrates which can include 1 g of sugar, 4 g of fat or oil from any source, and myceliated high protein food product solids sufficient to provide between about 2-30 g of protein.

The present invention can also include extruded and/or puffed products and/or cooked products comprising a myceliated high protein food product of the invention. Extruded and/or puffed ready-to-eat breakfast cereals and snacks such as crisps or scoops and pasta noodles are known in the art. Extrusion processes are well known in the art and appropriate techniques can be determined by one of skill.

For example, cold extrusion is used to gently mix and shape dough, without direct heating or cooking within the extruder. In food processing, it is used mainly for producing pasta and dough. These products can then be subsequently processed: dried, baked, vacuum-packed, frozen, etc.

Hot extrusion is used to thermomechanically transform raw materials in short time and high temperature conditions under pressure. In food processing, it is used mainly to cook biopolymer-based raw materials to produce textured food and feed products, such as ready-to-eat breakfast cereals, snacks (savory and sweet), pet foods, feed pellets, etc. The extruding can include, for example, melting and/or plasticization of the ingredients, gelatinization of starch and denaturation of proteins. The heat can be applied either through, for example, steam injection, external heating of the barrel, or mechanical energy. The material can be pumped, shaped and expanded, which forms the porous and fibrous texture, and partially dehydrates the product. The shape and size of the final product can be varied by using different die configurations. Extruders can be used to make products with little expansion (such as pasta), moderate expansion (shaped breakfast cereal, meat substitutes, breading substitutes, modified starches, pet foods (soft, moist and dry)), or a great deal of expansion (puffed snacks, puffed curls and balls, etc.).

The myceliated high protein food product of the invention may be used in formulating foods made by extrusion and/or puffing and/or cooking processes, such as ready to eat breakfast cereals and snack foods. These materials are formulated primarily with cereal grains and may contain flours from one or more cereal grains. The cereal grains utilized, such as corn, wheat, rice, barley, and the like, have a high starch content but relatively little protein. The breakfast cereal and snack materials can obtain the desired flake structure by a process known as puffing.

The food product produced using the methods described herein can be in the form of crunchy curls, puffs, chips, crisps, crackers, wafers, flat breads, biscuits, crisp breads, protein inclusions, cones, cookies, flaked products, fortune cookies, etc. The food product can also be in the form of pasta, such as dry pasta or a ready-to-eat pasta. The product can be used as or in a snack food, cereal, or can be used as an ingredient in other foods such as a nutritional bar, breakfast bar, breakfast cereal, or candy.

Food compositions of the invention also include bakery products and baking mixes comprising myceliated high protein food products according to the invention according to known methods. The term “bakery product” includes, but is not limited to leavened or unleavened, traditionally flour-based products such as white pan and whole wheat breads (including sponge and dough bread), cakes, pretzels, muffins, donuts, brownies, cookies, pancakes, biscuits, rolls, crackers, pie crusts, pizza crusts, hamburger buns, pita bread, and tortillas.

The present invention also includes food compositions such as granola cereals, and bar products, including such as granola bars, nutrition bars, energy bars, sheet and cut bars, extruded bars, baked bars, and combinations thereof.

For the extruded compositions, protein fortification may be accomplished by supplementing the bar with edible proteins from at least one high protein content source, as known in the art, and including the myceliated food product of the present invention, either alone or as combinations with other proteins Based upon the weight of the extrudate, or core, a suitable amount of the at least one high protein content source is about 20% to about 30% by weight. The protein content should be at least about 15% by weight, based upon the weight of the final product.

In one embodiment, the present invention includes a method to prepare a reaction flavor composition. In this embodiment, the edible material comprises providing at least one reaction flavor component capable of facilitating Maillard and/or Strecker reactions. In another step, the method includes mixing the myceliated high protein food product and the reaction flavor component. In yet another step, the method includes processing the mixture to form the reaction flavor composition.

In an embodiment, the present invention also includes a method to prepare a textured plant-based protein product useful for products such as meat-structured meat analogs or meat extenders. This textured plant-based meat analog or meat extender, in one embodiment, has texture associated with meat. The method optionally provides a “meat structured protein product” which can be made from the “texturized protein product” as disclosed herein. Integral to a meat structured protein product is a texturized protein product which refers to a product comprising protein fiber networks and/or aligned protein fibers that produce meat-like textures. It can be obtained from a dough after application of e.g., mechanical energy (e.g., spinning, agitating, shaking, shearing, pressure, turbulence, impingement, confluence, beating, friction, wave), radiation energy (e.g., microwave, electromagnetic), thermal energy (e.g., heating, steam texturizing), enzymatic activity (e.g., transglutaminase activity), chemical reagents (e.g., pH adjusting agents, kosmotropic salts, chaotropic salts, gypsum, surfactants, emulsifiers, fatty acids, amino acids), other methods that lead to protein denaturation and protein fiber alignment, or combinations of these methods, followed by fixation of the fibrous and/or aligned structure (e.g., by rapid temperature and/or pressure change, rapid dehydration, chemical fixation, redox), and optional post-processing after the fibrous and/or aligned structure is generated and fixed (e.g., hydrating, marinating, drying, coloring).

Extrusion is a technology to produce texturized proteins, a unique product which can be produced from a wide range of raw ingredient specifications, while controlling the functional properties such as density, rate and time of rehydration, shape, product appearance and mouthfeel.

The general procedure is as follows, as is known in the art. The flour mix is prepared and typically the dry ingredients are blended together in the premixture stage. In the optional preconditioning step (in a section of an extruder device known as preconditioner) the steam and water are usually added at this stage to wet/moisten and warm the flour mix. In the extruder, the majority of the work happens. Generally, the starch and protein are plasticized using heat, pressure and/or mechanical shear, then realigned and expanded as the mixture exits the extruder. The material coming from the extruder moisture ranges from 25% to 30%. Optionally, this extruded material can be dried to about 3%-5% moisture or less in the dryer portion. Cooling then optionally occurs to lower the temperature of the dried product to ambient conditions followed by an optional packaging step.

### EXAMPLES

### Example 1

Eighteen (18) 1 L baffled DeLong Erlenmeyer flasks were filled with 0.400 L of a medium consisting of 25 g/L organic pea protein concentrate (labeled as 80% protein), 25 g/L organic rice protein concentrate (labeled as 80% protein), 4 g/L organic dry malt extract, 2 g/L diammonium phosphate, 1 g/L organic carrot powder and 0.4 g/L magnesium sulfate heptahydrate in RO water. The flasks were covered with a stainless steel cap and sterilized in an autoclave on a liquid cycle that held the flasks at 120-121° C. for 90 minutes. The flasks were carefully transferred to a clean HEPA laminar flowhood where they cooled for 18 hours. Sixteen (16) flasks were subsequently inoculated with 2 cm² pieces of mature Petri plate cultures of P. ostreatus, P. eryngii, L. nuda, H. erinaceus, L. edodes, A. blazeii, L. sulfureus and B. edulis, each strain done in duplicate from the same plate. All 18 flasks were placed on a shaker table at 150 rpm with a swing radius of 1″ at room temperature. The Oyster (P. ostreatus), Blewit (Lepista nuda) and Lion's Mane (H. erinaceus) cultures were all deemed complete at 72 hours by way of visible and microscopic inspection (mycelial balls were clearly visible in the culture, and the isolation of these balls revealed dense hyphal networks under a light microscope). The other samples, but for the Porcini (Boletus edulis) which did not grow well, were harvested at 7 days. All samples showed reduced pea and reduced rice aroma and flavor, as well as less “beany” type aromas/flavors. The Oysters had a specifically intense savory taste and back-end mushroom flavor. The Blewit was similar but not quite as savory. The Lion's Mane sample had a distinct ‘popcorn’ aroma. The 3, 7 day old samples were nearly considered tasteless but for the Chicken of the Woods (Laetiporus sulphureus) sample product which had a nice meaty aroma and had no pea or rice aroma/flavor. The control sample smelled and tasted like a combination of pea and rice protein and was not considered desirable. The final protein content of every the resulting cultures was between 50-60% and the yields were between 80-90% after desiccation and pestling.

### Example 2

Three (3) 4 L Erlenmeyer flasks were filled with 1.5 L of a medium consisting of 5 g/L pea protein concentrate (labeled as 80% protein), 5 g/L rice protein concentrate (labeled as 80% protein), 3 g/L malt extract and 1 g/L carrot powder. The flasks were wrapped with a sterilizable biowrap which was wrapped with autoclave tape 5-6 times (the taped biowrap should be easily taken off and put back on the flask without losing shape) and sterilized in an autoclave that held the flasks at 120−121° C. for 90 minutes. The flasks were carefully transferred to a clean HEPA laminar flowhood where they cooled for 18 hours. Each flask was subsequently inoculated with 2 cm² pieces of 60 day old P1 Petri plate cultures of L. edodes and placed on a shaker table at 120 rpm with a 1″ swing radius at 26° C. After 7-15 days, the inventors noticed, by using a pH probe on 20 mL culture aliquots, that the pH of every culture had dropped nearly 2 points since inoculation. L. edodes is known to produce various organic acids on or close to the order of g/L and the expression of these acids are likely what dropped the pH in these cultures. A microscope check was done to ensure the presence of mycelium and the culture was plated on LB media to ascertain the extent of any bacterial contamination. While this culture could have been used as a food product with further processing (pasteurization and optionally drying), the inventors typically use such cultures as inoculant for bioreactor cultures of media prepared as disclosed according to the methods of the present invention.

### Example 3

A 7 L bioreactor was filled with 4.5 L of a medium consisting of 5 g/L pea protein concentrate (labeled as 80% protein), 5 g/L rice protein concentrate (labeled as 80% protein), 3 g/L malt extract and 1 g/L carrot powder. Any open port on the bioreactor was wrapped with tinfoil and sterilized in an autoclave that held the bioreactor at 120-121° C. for 2 hours. The bioreactor was carefully transferred to a clean bench in a cleanroom, setup and cooled for 18 hours. The bioreactor was inoculated with 280 mL of inoculant from a 12 day old flask as prepared in Example 2. The bioreactor had an air supply of 3.37 L/min (0.75 VVM) and held at 26° C. A kick-in/kick-out anti-foam system was setup and it was estimated that ˜1.5 g/L anti-foam was added during the process. At ˜3-4 days the inventors noticed that the pH of the culture had dropped ˜1.5 points since inoculation, similar to what was observed in the flask culture. A microscope check was done to ensure the presence of mycelium (mycelial pellets were visible by the naked eye) and the culture was plated on LB media to ascertain the extent of any bacterial contamination and none was observed. While this culture could have been used as a food product with further processing (pasteurization and optionally drying), the inventors typically use such cultures as inoculant for bioreactor cultures of media prepared as disclosed according to the methods of the present invention.

### Example 4

A 250 L bioreactor was filled with 150 L of a medium consisting of 45 g/L pea protein concentrate (labeled as 80% protein), 45 g/L rice protein concentrate (labeled as 80% protein), 1 g/L carrot powder, 1.8 g/L diammonium phosphate, 0.7 g/L magnesium sulfate heptahydrate, 1 g/L anti-foam and 1.5 g/L citric acid and sterilized in place by methods known in the art, being held at 120-121° C. for 100 minutes. The bioreactor was inoculated with 5 L of inoculant from two bioreactors as prepared in Example 3. The bioreactor had an air supply of 30 L/min (0.2 VVM) and held at 26° C. The culture was harvested in 4 days upon successful visible (mycelial pellets) and microscope checks. The pH of the culture did not change during processing but the DO dropped by 25%. The culture was plated on LB media to ascertain the extent of any bacterial contamination and none was observed. The culture was then pasteurized at 82° C. for 30 minutes with a ramp up time of 30 minutes and a cool down time of 45 minutes to 17° C. The culture was finally spray dried and tasted. The final product was noted to have a mild aroma with no perceptible taste at concentrations up to 10%. The product was ˜75% protein on a dry weight basis.

### Example 5

A 250 L bioreactor was filled with 150 L of a medium consisting of 45 g/L pea protein concentrate (labeled as 80% protein), 45 g/L rice protein concentrate (labeled as 80% protein), 1 g/L carrot powder, 1.8 g/L diammonium phosphate, 0.7 g/L magnesium sulfate heptahydrate, 1 g/L anti-foam and 1.5 g/L citric acid and sterilized in place by methods known in the art, being held at 120-121° C. for 100 minutes. The bioreactor was inoculated with 5 L of inoculant from two bioreactors as prepared in Example 3. The bioreactor had an air supply of 30 L/min (0.2 VVM) and held at 26° C. The culture was harvested in 2 days upon successful visible (mycelial pellets) and microscope checks. The pH of the culture did not change during processing but the DO dropped by 25%. The culture was plated on LB media to ascertain the extent of any bacterial contamination and none was observed. The culture was then pasteurized at 82° C. for 30 minutes with a ramp up time of 30 minutes and a cool down time of 90 minutes to 10° C. The culture was finally concentrated to 20% solids, spray dried and tasted. The final product was noted to have a mild aroma with no perceptible taste at concentrations up to 10%. The product was ˜75% protein on a dry weight basis.

The amount of lactic acid in the final product (Product Batch 1 and 2 are from to different fermentation runs) were as follows, as shown in Table 1:

TABLE 1

| Product | Lactic Acid |
|---|---|
| Batch | (g/L) |
| 1 | 0.13 |
| 2 | 0.14 |

### Example 6

Eight (8) 1 L baffled DeLong Erlenmeyer flasks were filled with 0.4 L of media consisting of 45 g/L pea protein concentrate (labeled as 80% protein), 45 g/L rice protein concentrate (labeled as 80% protein), 1 g/L carrot powder, 1 g/L malt extract, 1.8 g/L diammonium phosphate and 0.7 g/L magnesium sulfate heptahydrate and sterilized in an autoclave being held at 120-121° C. for 90 minutes. The flasks were then carefully placed into a laminar flowhood and cooled for 18 hours. Each flask was inoculated with 240 mL of culture as prepared Example 2 except the strains used were G. lucidum, C. sinensis, I. obliquus and H. erinaceus, with two flasks per species. The flasks were shaken at 26° C. at 120 RPM with a 1″ swing radius for 8 days, at which point they were pasteurized as according to the parameters discussed in Example 5, desiccated, pestled and tasted. The G. lucidum product contained a typical ‘reishi’ aroma, which most of the tasters found pleasant. The other samples were deemed pleasant as well but had more typical mushroom aromas.

As compared to the control, the pasteurized, dried and powdered medium not subjected to sterilization or myceliation, the resulting myceliated food products was thought to be much less bitter and to have had a more mild, less beany aroma that was more cereal in character than beany by 5 tasters. The sterilized but not myceliated product was thought to have less bitterness than the nonsterilized control but still had a strong beany aroma. The preference was for the myceliated food product.

### Example 7

Fermentation Operation in 4,000 L Bioreactor Using Continuous Sterilizer

A 4,000 L bioreactor was filled with 2,500 L of a sterilized medium similar to Example 4, consisting of 45 g/L pea protein concentrate (labeled as 80% protein), 45 g/L rice protein concentrate (labeled as 80% protein), 3.6 g/l maltodextrin, 1.8 g/L carrot powder, 1.8 g/L diammonium phosphate, 0.7 g/L magnesium sulfate heptahydrate, 1.5 g/L anti-foam and 0.6 g/L citric acid. Seed reactor was also prepared in 200 L bioreactor with medium volume of 100 L with the following medium components: pea protein 5 g/l, rice protein 5 g/l, maltodextrin 3.0 g/l, carrot powder 1 g/l, malt extract 3 g/l and 1.25 g/l of anti-foam. The medium was inoculated with flask process developed the same way as shown in Example 2. Inoculum was harvested when pH was 4.7+/−0.1. The 200 L bioreactor was harvested 55 hours post-inoculation. The flasks were harvested 11 days post-inoculation. The organism was Lentinula edodes sourced from the Penn State mushroom culture collection.

Once the main fermenter was cooled it was inoculated with the 100 L inoculum from the 200 L fermentor. Fermenter had an air supply of 100 to 400 L/min (0.1-0.2 VVM) and held at 26° C. The culture in the 4,000 L vessel was harvested at 48 hours post-inoculation upon successful visible (mycelial pellets) and microscope checks. No pH change was observed during the fermentation. Material was pasteurized in the bioreactor at 65 C for 60 minutes. Fermenter was then cooled down and material was harvested in sanitized 55 gallon drums and sent to spray drying facility.

### Example 8

Fermentation Operation in 10,000 L Fermenter

A 10,000-L bioreactor was prepared with the following medium components for a working volume of 6,200 L. pea protein 45 g/l, rice protein 45 g/l, maltodextrin 3.6 g/l, carrot powder 1.8 g/l, magnesium sulfate 0.72 g/l, di ammonium phosphate 1.8 g/l, citric acid 0.6 g/l, and 1.25 g/l of anti-foam added at the end of the charge. Medium was sterilized for 2 hours at 126° C. Medium was inoculated from 2000 L fermenter with a volume of 300-350 L. The aeration was maintained between 0.13 vvm and 0.25 vvm. Agitation was maintained to get a tip speed of 0.88 m/sec. Additional anti-foam of 0.25 g/l was added to contain the foaming. pH of the medium remained at 6.1 throughout the fermentation. Temperature for the fermentation as maintained at 26° C. Pressure in the fermenter was increased from 0.1 bar to 1.2 bar during the course of fermentation to minimize the foaming. Fermentation was completed in 45-50 hours. After completion of fermentation the fermented broth was pasteurized and concentrated to 20% and then spray dried.

The seed inoculum for the fermentation was prepared in a 2000 L fermentor with a working volume of 530-540 L with the following medium: pea protein 5 g/l, rice protein 5 g/l, maltodextrin 3.0 g/l, carrot powder 1 g/l, malt extract 3 g/l and 1.5 g/l of anti-foam. Fermentation pH was at 5.7 at the beginning of the fermentation. Fermentation was performed for 60 to 70 hours when pH reached between 4.6 and 4.9. The tip speed in the fermenter was maintained at 0.5-0.6 m/s. Aeration was done at 0.65-0.75 vvm. Fermenter was maintained at a pressure of 0.4-0.6 bar. Seed 1 for the inoculation of fermenter 2 was prepared in 150 L with a working volume of 55-65 L with the following medium: pea protein 5 g/l, rice protein 5 g/l, maltodextrin 3.0 g/l, carrot powder 1 g/l, malt extract 3 g/l, mango puree 3 g/l and 1.5 g/l of anti-foam. Fermentation pH was at 5.7 at the beginning of the fermentation. The tip speed in the fermenter was maintained at 0.69 m/s and pressure was maintained at 0.5 bar. Aeration was done at a rate of 0.75 vvm. The initial pH for the fermentation was at 5.7. Fermentation was completed between 45 and 55 hours. Inoculum for Seed 1 was prepared with the 5 flask prepared in 3 L flask with the following medium::Pea Protein 5 g/l, Rice Protein 5 g/l, Maltodextrin 3.0 g/l, Carrot Powder 1 g/l, malt extract 3 g/l, mango puree 3 g/l and 1.25 g/l of anti-foam. Flask were inoculated with 4 cm² agar and incubated between 11 and 13 days. pH of the flask was obtained at 4+/−2.

### Example 9

Fermentation Operation in 180,000 L Fermenter

The medium for 180,000 L bioreactor was prepared as a volume of 120,000 L with the following components: pea protein 45 g/l (labeled as 80% protein), rice protein 45 g/l (labeled as 80% protein), maltodextrin 3.6 g/l, carrot powder 1.8 g/l, magnesium sulfate 0.72 g/l, di ammonium phosphate 1.8 g/l, citric acid 0.6 g/l, and 1.25 g/l of anti-foam added at the end of the charge. The 180,000 L bioreactor was harvested at 48 hours.

The inoculum for the 180,000 L bioreactor was 6,200 L from a 10,000 L bioreactor prepared similar to the medium of Example 3. The 6,200 L bioreactor in turn was inoculated with 65 L of culture in a 150 L bioreactor prepared similar to the 6,200 L medium and was cultured to just before stationary phase. The 65 L medium was inoculated with flasks of Lentinula edodes in medium similar to that of the medium of Example 3 and cultured to stationary phase. These flasks had been inoculated with Lentinula edodes from the Penn State mushroom culture collection and culture to stationary phase.

### Example 10

Sensory Data

Eight protein powders were tested: (a) raw material (3.2 pea); (b) raw material (pea); (c) raw material (rice); (d) raw material (rice); (e) myceliated material 3; (f) myceliated material 4; (g) myceliated material 4.2; and (h) myceliated material 3.2. Each protein powder was tested at 7% in water. Trained descriptive panelists used a consensus descriptive analysis technique to develop the language, ballot and rate profiles of the protein powders. The aroma language was as follows:

Overall aroma: the intensity of the total combined aroma; pea aroma, the aroma of dried peas/pea starch (reference; ground dried peas); beany aroma, the aroma of beans/bean starch (reference; ground dried lentils); rice aroma, the aroma of white rice (reference, cooked minute rice); mushroom aroma, the aroma of mushrooms (reference, dried shiitake mushrooms); overripe vegetable aroma, the aroma of soft overripe vegetables; and cardboard aroma, the aroma of pressed wet cardboard (reference: wet pressed cardboard).

The taste language was as follows: sweet, taste on the tongue stimulated by sugar in solution (reference, Domino Sugar in distilled water); sour, acidic taste on the tongue associated with acids in solution (reference, citric acid in distilled water); umami, the savory taste of MSG (reference; MSG in distilled water); bitter, basic taste on tongue associated with caffeine solutions (reference, caffeine powder in distilled water); astringent, the drying, puckering feeling associated with tannins (reference Mott's Apple Juice (40) Welch's Grape Juice (75)).

Flavor language was as follows: overall flavor, the composite intensity of all flavors as experienced while drinking the product; overripe vegetable, the flavor of soft overripe vegetables; pea, the flavor of dried peas/pea starch (reference: ground dried peas); beany, the flavor of beans/bean starch (reference: ground dried lentils; canned garbanzo beans); rice, the flavor of white rice (reference: cooked minute rice); mushroom, the flavor of mushrooms (reference: dried shiitake mushrooms); soapy, reminiscent of soap; chalky, the flavor associated with chalk and calcium (reference: citrucel gummies); cardboard, the flavor of pressed wet cardboard (reference: wet pressed cardboard); earthy, the flavor of fresh earth/dirt (reference: potting soil).

The raw pea product prior to myceliation has a pea aroma with no rice or mushroom aroma. The rice samples prior to myceliation have rice aroma with no pea or mushroom aroma. After myceliation, these samples have mushroom aroma and no pea or rice aroma, respectively. There is also increased umami flavor in the myceliated samples.

### Example 11

Eight (8) 1 L baffled DeLong Erlenmeyer flasks were filled with 0.500 L of the following 8 different media, after the manner of Example 1, see Table 2:

TABLE 2

| Component | Medium 1 | Medium 2 | Medium 3 | Medium 4 | Medium 5 | Medium 6 | Medium 7 | Medium 8 |
|---|---|---|---|---|---|---|---|---|
| Pea protein 1 | 54 | 54 | 49.5 | 54 | 54 | 54 | 0 | 54 |
| (g/L) | | | | | | | | |
| Chickpea powder | 36 | 36 | 22.5 | 36 | 36 | 36 | 36 | 36 |
| (g/L) | | | | | | | | |
| Rice protein (g/L) | 0 | 0 | 18 | 0 | 0 | 0 | 0 | 0 |
| Magnesium | 0.72 | 0.72 | 0.72 | 0.72 | 0.72 | 0.72 | 0.72 | 0.72 |
| sulfate (g/L) | | | | | | | | |
| Diammonium | 1.8 | 1.8 | 1.8 | 1.8 | 1.8 | 1.8 | 1.8 | 1.8 |
| phosphate (g/L) | | | | | | | | |
| Citric acid (g/L) | 1.5 | 1.5 | 1.5 | 1.5 | 0.6 | 0.9 | 1.5 | 1.5 |
| Carrot powder | 1.8 | 1.8 | 1.8 | 1.8 | 1.8 | 1.8 | 0 | 1.8 |
| (g/L) | | | | | | | | |
| Anti-foam 1 (g/L) | 1.25 | 0 | 1.25 | 1.25 | 1.25 | 1.25 | 1.25 | 1.25 |
| (organic polymer | | | | | | | | |
| based) | | | | | | | | |
| Pea protein 2 | 0 | 0.1 | 0 | 0 | 0 | 0 | 54 | 0 |
| (g/L) | | | | | | | | |
| Anti-foam 2 (g/L) | 0 | 0.1 | 0 | 0 | 0 | 0 | 0 | 0 |
| (silicone based) | | | | | | | | |
| Vegetable juice | 0 | 0 | 0 | 0 | 0 | 0 | 5 | 0 |
| (mL/L) | | | | | | | | |

The flasks were covered with a stainless-steel cap and steam sterilized. The flasks were carefully transferred to a clean HEPA laminar flow hood where they cooled for 4 hours and each were inoculated with 5% of 10-day old submerged Lentinula edodes. All 8 flasks were placed on a shaker table at 150 rpm with a swing radius of 1″ at room temperature and allowed to incubate for 3 days. Plating aliquots of each sample on LB and petri film showed no contamination in any flask. The pH changes during processing is shown below, and is essentially the same (within the margin of error of the pH meter). See Table 3.

TABLE 3

| Medium | pH, T = 0 | pH T = 3 days |
|---|---|---|
| 1 | 6.09 | 6.04 |
| 2 | 6.00 | 5.92 |
| 3 | 5.90 | 5.83 |
| 4 | 6.01 | 5.97 |
| 5 | 6.56 | 6.35 |
| 6 | 6.38 | 6.23 |
| 7 | 5.79 | 5.79 |
| 8 | 6.05 | 5.93 |

Top performing recipes in sensory from these 8 media were media 5 and 7. Bitterness and sourness were evaluated and these two media showed the best results, although all media exhibited reduced undesirable flavors and reduced aromas, such as reduced beany aroma, pea aroma, or rice aroma and reduced beany taste, pea taste, rice taste, and bitter taste. The sensory evaluation included 15 tasters, all tasting double-blind, randomized samples and providing a descriptive analysis. These recipes were further evaluated for strain screening work as described in Example 12.

### Example 12

Eight (8) 1 L baffled DeLong Erlenmeyer flasks were filled with 0.500 L of medium consisting of the 2 best medium as described in example 11 (4 flasks for each medium). These two media were inoculated with four different species: Lentinula edodes, Boletus edulis, Pleurotus salmoneostramineus and Morchella esculenta. See Table 4.

TABLE 4

| Component | Medium 1 | Medium 2 |
|---|---|---|
| Pea protein 1 (g/L) | 54 | 0 |
| Chickpea powder (g/L) | 36 | 36 |
| Magnesium sulfate (g/L) | 0.72 | 0.72 |
| Diammonium phosphate | 1.8 | 1.8 |
| (g/L) | | |
| Citric Acid (g/L) | 0.6 | 1.5 |
| Carrot powder (g/L) | 1.8 | 1.8 |
| Pea protein 2 (g/L) | 0 | 54 |
| Anti-foam 2 (g/L) | 0.1 | 0.1 |

The flasks were covered with a stainless-steel cap and sterilized in an autoclave. The flasks were carefully transferred to a clean HEPA laminar flow hood where they cooled for 4 hours and inoculated with 5% of 10-day old submerged aliquots of each species. All 8 flasks were placed on a shaker table at 150 rpm with a swing radius of 1″ at room temperature and incubated for 3 days at which point pH was measured and is summarized below (see Table 5):

TABLE 5

| Media | Species | pH = To | pH = 3 days |
|---|---|---|---|
| 1 | Lentinula edodes | 6.55 | 6.38 |
| 1 | Boletus edulis | 6.58 | 6.45 |
| 1 | Pleurotus | 6.55 | 6.44 |
| | salmoneostramineus | | |
| 1 | Morchella esculenta | 6.55 | 5.42 |
| 2 | Lentinula edodes | 5.77 | 5.71 |
| 2 | Boletus edulis | 5.77 | 5.74 |
| 2 | Pleurotus | 5.76 | 5.88 |
| | salmoneostramineus | | |
| 2 | Morchella esculenta | 5.77 | 5.36 |

Plating aliquots of each sample on petri film showed no contamination in any flask. Bitterness and sourness were evaluated and these two media showed the best results, although all media exhibited such as reduced beany aroma, pea aroma, or rice aroma and reduced beany taste, pea taste, rice taste, and bitter taste. The results that were obtained showed that Boletus edulis performed better than other species for lower sourness and bitterness. M. esculenta did not perform well.

### Example 13

A 7 L bioreactor was filled with 4.5 L of a medium consisting of the medium as described in following table (see Table 6):

TABLE 6

| Component | Medium 1 | Medium 2 | Medium 3 |
|---|---|---|---|
| Pea protein 1 (g/L) | 45 | 45 | 58.5 |
| Rice Protein (g/L) | 45 | 45 | 31.5 |
| Anti-foam 2 (g/L) | 1.25 | 1.25 | 1.25 |

In this experiment, excipients other than an anti-foam were omitted from the fermentation medium, and only rice protein, pea protein, and anti-foam were used as the medium. In previous examples, excipients such as magnesium sulfate, diammonium phosphate (which functions at least in part as a buffer), citric acid, carrot powder, were used and are omitted here. It was theorized that omission of these excipients will encourage the culture to convert protein metabolically and not proliferate. Open ports on the bioreactor were wrapped in foil and the vessel was subsequently sterilized in an autoclave. The bioreactors were carefully transferred to a clean bench in a cleanroom, setup and cooled for 4-6 hours. The bioreactor was inoculated with 5%, 10% and 7.5% of inoculant of L. edodes from a 12-day old flask. Fermentation for these batches was completed in 44 hours, 24 hours and 30 hours respectively for medium 1, medium 2 and medium 3. A microscope check was done to ensure the presence of mycelium (mycelial pellets were visible by the naked eye) and the culture was plated on LB media to ascertain the extent of any bacterial contamination and none was observed. These cultures were pasteurized for 60 minutes at 65° C. and organoleptic taste assessments were conducted. Following table summarizes the pH at the harvest (see Table 7):

TABLE 7

| Component | Medium 1 | Medium 2 | Medium 3 |
|---|---|---|---|
| pH t = 0 | 6.8 | 6.83 | 6.8 |
| pH Harvest | 6.56 | 6.68 | 6.58 |
| Delta pH | 0.24 | 0.15 | 0.22 |
| Harvest time | 24 | 30 | 44 |
| (hours) | | | |

Microscopic examination of these different inoculum and protein samples was done and it suggested growth even for medium 1 at 24 hours fermentation. Another interesting finding for this study was a modest pH change of up to 0.25 units. This could be explained by the fact that the medium omitted the buffering compound diammonium phosphate from the medium

Bitterness and sourness were evaluated and these two media showed the best results, although all media exhibited reduced beany aroma, pea aroma, or rice aroma and reduced beany taste, pea taste, rice taste, and bitter taste.

### Example 14. Increase in Digestibility and Improved Organoleptics of a Pea and Rice Protein

Strain and protein blend fermentation: Lentinula edodes (shiitake) strain WC1008 was obtained from Penn State fungal collection. Shiitake mycelium as stored in sorghum spawn at −80 C as described in patent application U.S. Pat. No. 10,010,103. Fermented pea and rice samples were generated according to the process described in patent application U.S. Pat. No. 10,010,103, which is incorporated by reference herein in its entirety. Fermented and unfermented protein blend samples were kept in airtight containers at room temperature.

Digestibility and pig studies:

Two diets were formulated with the unfermented and fermented protein blends included in one diet each as the only AA (amino acid)-containing ingredient. The third diet was a nitrogen-free diet that was used to measure basal endogenous losses of CP and AA. Vitamins and minerals were included in all diets to meet or exceed current requirement estimates for growing pigs. All diets also contained 0.4% titanium dioxide as an indigestible marker, and all diets were provided in meal form.

At the conclusion of the experiment, ileal samples were thawed, mixed within animal diet, and a sub-sample was collected for chemical analysis. Ileal digesta samples were lyophilized and finely ground prior to chemical analysis. Fecal samples were dried in a forced-air oven and ground through a 1 mm screen in a Wiley Mill (model 4, Thomas Scientific) prior to chemical analysis. All samples were analyzed for dry matter (DM; Method 927.05) and for CP by combustion (Method 990.03) at the Monogastric Nutrition Laboratory at the University of Illinois Champagne, Ill. All diets, fecal samples, and ileal digesta were analyzed in duplicate for titanium (Method 990.08; Myers et al., 2004). The two proteins, all diets, and ileal digesta samples were also be analyzed for AA [Method 982.30 E (a, b, c)].

Values for apparent ileal digestibility (AID) and standardized ileal digestibility (SID) of CP and AA were calculated, and standardized total tract digestibility (STTD) of CP were calculated as well. Values for STTD and SID were used to calculate values for PDCAAS and PDCAAS-like, and DIAAS, respectively, as previously explained. Reference publications: Mathai, J. K., Liu, Y. & Stein, H. H. Values for digestible indispensable amino acid scores (DIAAS) for some dairy and plant proteins may better describe protein quality than values calculated using the concept for protein digestibility-corrected amino acid scores (PDCAAS). Br. J. Nutr. Camb. 117, 490-499 (2017). Howitz, W. & Jr. Latimer G. W. in AOAC International. 2007. Official Methods of Analysis. 18th ed. Rev. 2. (Association of Official Analytical Chemist International). Leser, S. The 2013 FAO report on dietary protein quality evaluation in human nutrition: Recommendations and implications. Nutr. Bull. 38, 421-428 (2013). Abelilla, J. J., Liu, Y. & Stein, H. H. Digestible indispensable amino acid score (DIAAS) and protein digestibility corrected amino acid score (PDCAAS) in oat protein concentrate measured in 20- to 30-kilogram pigs: Evaluation of oat protein concentrate. J. Sci. Food Agric. 98, 410-414 (2018).

The protocol for the animal work was reviewed and approved by the Institutional Animal Care and Use Committee at the University of Illinois (Protocol Number 16113).

Diets (fermented and unfermented) had nutrient compositions as shown in Table 8. Three diets were formulated with the fermented and unfermented protein included in one diet each as the only amino acid (AA) containing ingredient (Table 9). Diet 3 was a nitrogen-free diet that was used to measure basal endogenous losses of crude protein (CP) and AA. Vitamins and minerals were included in all diets to meet or exceed current requirement estimates for growing pigs (National Research Council; NRC, 2012). All diets also contained 0.4% titanium dioxide as an indigestible marker, and all diets were provided in meal form. A sample of each diet were collected and sub-sampled at the time of diet mixing. One sub-sample was used for chemical analysis of the ingredients and diets.

TABLE 8
Analyzed nutrient composition of ingredients (as-fed) basis¹

| Item, % | Unfermented | Fermented |
|---|---|---|
| Dry matter | 96.90 | 95.64 |
| Crude protein | 77.57 | 76.77 |

Indispensable AA

| | | |
|---|---|---|
| Arg | 6.60 | 6.34 |
| His | 1.95 | 1.87 |
| Ile | 3.84 | 3.63 |
| Leu | 6.54 | 6.39 |
| Lys | 5.33 | 3.97 |
| Met | 1.06 | 1.44 |
| Phe | 4.28 | 4.23 |
| Thr | 2.79 | 2.69 |
| Trp | 0.79 | 0.83 |
| Val | 4.33 | 4.49 |
| Total | 37.51 | 35.88 |

Dispensable AA

| | | |
|---|---|---|
| Ala | 3.51 | 3.77 |
| Asp | 8.28 | 7.52 |
| Cys | 0.85 | 1.06 |
| Glu | 12.54 | 12.78 |
| Gly | 3.13 | 3.18 |
| Pro | 3.27 | 3.37 |
| Ser | 3.34 | 3.24 |
| Tyr | 3.18 | 3.51 |
| Total | 38.10 | 38.43 |
| Total AA | 75.61 | 74.31 |

¹AA = amino acid.

TABLE 9
Ingredient composition of experimental diets (as-fed basis)

| Item, % | unfermented | fermented | N-free |
|---|---|---|---|
| Protein | 17.00 | 17.00 | — |
| Corn starch | 51.85 | 51.85 | 67.85 |
| Solka floc | 3.00 | 3.00 | 4.00 |
| Soybean oil | 4.00 | 4.00 | 4.00 |
| Sucrose | 20.00 | 20.00 | 20.00 |
| Limestone | 0.70 | 0.70 | 0.70 |
| Dicalcium phosphate | 2.00 | 2.00 | 2.00 |
| Magnesium oxide | 0.10 | 0.10 | 0.10 |
| Potassium carbonate | 0.40 | 0.40 | 0.40 |
| Sodium chloride | 0.40 | 0.40 | 0.40 |
| Titanium dioxide | 0.40 | 0.40 | 0.40 |
| Vitamin mineral premix¹ | 0.15 | 0.15 | 0.15 |

¹The vitamin-micromineral premix provided the following quantities of vitamins and micro minerals per kilogram of complete diet: vitamin A as retinyl acetate, 11,136 IU; vitamin D3 as cholecalciferol, 2,208 IU; vitamin E as DL-alpha tocopheryl acetate, 66 IU; vitamin K as menadione dimethylpyrimidinol bisulfite, 1.42 mg; thiamin as thiamine mononitrate, 0.24 mg; riboflavin, 6.59 mg; pyridoxine as pyridoxine hydrochloride, 0.24 mg; vitamin B12, 0.03 mg; D-pantothenic acid as D-calcium pantothenate, 23.5 mg; niacin, 44.1 mg; folic acid, 1.59 mg; biotin, 0.44 mg; Cu, 20 mg as copper sulfate and copper chloride; Fe, 126 mg as ferrous sulfate; I, 1.26 mg as ethylenediamine dihydriodide; Mn, 60.2 mg as manganese sulfate; Se, 0.3 mg as sodium selenite and selenium yeast; and Zn, 125.1 mg as zinc sulfate.

Nine growing barrows (initial BW: 28.5±2.3 kg) were equipped with a T-cannula in the distal ileum (Stein et al., 1998) and allotted to a triplicated 3×3 Latin square design with 3 pigs and 3 periods in each square. Diets were randomly assigned to pigs in such a way that within each square, one pig receive each diet, and no pig received the same diet twice during the experiment. Therefore, there were 9 replicate pigs per treatment for the 3 Latin squares. Pigs were housed in individual pens (1.2×1.5 m) in an environmentally controlled room. Pens had have smooth sides and fully slatted tribar floors. A feeder and a nipple drinker were also installed in each pen.

All pigs were fed their assigned diet in a daily amount of 3.3 times the estimated energy requirement for maintenance (i.e., 197 kcal ME per kg^{0.60}; NRC, 2012). Two equal meals were provided every day at 0800 and 1600 h, and water was available at all times. Pig weights were recorded at the beginning and at the conclusion of the experimental period, and the amount of feed supplied each day was recorded. The experimental period was 9 d, with the initial 5 d considered an adaptation period to the diet. Fecal samples were collected in the morning of d 6, 7, and 8 by anal stimulation and immediately frozen at −20° C. Ileal digesta were collected for 9 hours (from 0800 to 1700 h) on d 8 and 9 following standard operating procedures (Stein et al., 1998). In short, a plastic bag was attached to the cannula barrel and digesta flowing into the bag were collected. Bags were removed once filled with ileal digesta, or at least once every 30 minutes, and immediately frozen at −20° C. to prevent bacterial degradation of AA in the ileal digesta.

At the conclusion of the experiment, ileal samples were thawed, mixed within animal and diet, and a sub-sample was collected for chemical analysis. Ileal digesta samples were lyophilized and finely ground prior to chemical analysis. Fecal samples were dried in a forced-air oven and ground through a 1 mm screen in a Wiley Mill (model 4, Thomas Scientific) prior to chemical analysis. All samples were analyzed for dry matter (DM; Method 927.05; AOAC International, 2007) and for CP by combustion (Method 990.03; AOAC International, 2007) at the Monogastric Nutrition Laboratory at the University of Illinois. The analysis for DM and CP were repeated if the analyzed values are more than 2% apart. All diets, fecal samples, and ileal digesta were analyzed in duplicate for titanium (Method 990.08; Myers et al., 2004). The diets, and ileal digesta samples were also be analyzed for AA [Method 982.30 E (a, b, c); AOAC International, 2007].

Values for apparent ileal digestibility (AID) and standardized ileal digestibility (SID) of CP and AA were calculated (Stein et al., 2007), and standardized total tract digestibility (STTD) of CP were calculated as well (Mathai et al., 2017). Average values for basal endogenous losses of CP and AA used to calculate SID values (Sotak-Peper et al., 2017), in addition, an average value for basal endogenous losses of CP were calculated from 2 previously conducted experiments in our laboratory to calculate STTD.

The equation to determine STTD of CP from ATTD of CP was as follows:

STTD,%=ATTD+[(basal CP_{end}/CP_{diet})×100]

Where basal CP_{end} represents the basal endogenous losses of CP (% dry matter). The CP_{diet} represents the crude protein concentration in the diet (dry matter basis).

Values for STTD and SID were then used to calculate values for PDCAAS and PDCAAS-like, and DIAAS, respectively, as previously explained (FAO, 2013; Mathai et al., 2017; Abelilla et al., 2018).

GC-O and CHARM analysis: quantification of volatile compounds in fermented and unfermented protein blend samples was done by gas chromatography/olfactometry (GC/0) using human “sniffers” to assay for odor activity among volatile analytes as previously described.

Solubility: Solubility of protein samples was calculated as:

$$\% Solubility = \frac{{m}_{dry powder filterate}}{{m}_{dry powder total}} = \frac{{m}_{dry powder filterate}}{{m}_{initial powder total} - \% Moisture * {m}_{initial powder total}}$$

Sample moisture was calculated after placing 5 g of protein powder in a desiccator and recording the dried weight, as follows:

$$\% Moisture = \frac{{m}_{initial powder} - {m}_{dry powder}}{{m}_{initial powder}} * 100 \%$$

Dry powder filtrate was calculated by dissolving 2.5 g of dried sample in 50 ml at room temperature and adjusting the pH to either 3.0, 5.0, 6.0, 7.0, or 8.0, with 1M HCl or 1M NaOH. Samples were mixed thoroughly and centrifugated at 9000 RPM for 10 minutes. Supernatant was vacuum filtrated using GE Whatman 47 mm Grade 4 filter papers (GE) and the weight recorded.

Digestibility of Fermented Pea and Rice Protein Concentrate Blend

Nutritional analysis of the unfermented and fermented protein blends indicated that the crude protein (CP) content was similar in both samples with 77.57% and 76.77% respectively. The concentrations of all but one indispensable AA were also similar in both protein blends, with unfermented (37.51%) and fermented (35.88%). The exception was Lysine (Lys), which was approximately 25% greater in unfermented sample. To assess the digestibility of the both blends, pig ileal digestibility studies were conducted.

The PDCAAS values were calculated using the FAO recommended scoring patterns for “young children” (6 months to 3 years) and for “older children, adolescents, and adults” (3+ years), and found not to be different between unfermented and fermented protein blends for both age groups. For young children, PDCAAS values were similar to those calculated for children 2 to 5 year, with the unfermented and fermented proteins having PDCAAS values of 86 and 91, respectively. For PDCAAS values calculated for older children, unfermented and fermented proteins had values of 101 and 108, respectively. The first limiting AA when compared with the AA requirements was SAA and Lys for unfermented protein and fermented protein, respectively, for both age groups.

DIAAS was calculated for “young children” and for “older children, adolescents, and adults”. The DIAAS calculated for both age groups was greater (P<0.05) for the fermented than for the unfermented pea-rice protein. For young children, the DIAAS was 70 and 86 for unfermented and fermented proteins, respectively, which represents a 23% increase. For older children, adolescents, and adults, the DIAAS was 82 and 102 for unfermented and fermented proteins, respectively, which represents a 24% increase. The first limiting AA in the proteins when compared with the AA requirements for both age groups was SAA and Lys for unfermented and fermented proteins, respectively.

Solubility and Antinutrient Levels of Fermented Pea and Rice Protein Blend

To determine if the fermentation process also impacts physical properties of the pea and rice protein blend, the solubility of the fermented and unfermented protein concentrate blends was calculated across a wide range of pH. The dissolved solids of three independent fermented protein blend samples were consistently higher than that of unfermented protein blend (raw pea+rice) showing an increase at all pH values. The minimal increase in dissolved solids in the fermented samples over the mixture of raw materials was 2-fold and occurred at pH 5, while the highest increase was 3-fold, at pH 8.

To assess the reduction of protein inhibitors of key proteases due to the fermentation process, we conducted inhibitory enzyme assays. No changes in trypsin, chymotrypsin and subtilisin inhibition were observed between unfermented and fermented protein blends (data not shown).

The presence of residual phytate in plant protein can negatively affect protein digestibility. To evaluate the ability of shiitake fermentation to remove phytic acid the levels of phytate were measured in both unfermented and fermented protein blends. The percentage of phytic acids in the unfermented and fermented protein blends were 1.25% and 0.68%, respectively. These results indicate changes in physical properties and chemical composition of the fermented protein blend.

Phytate measurement: Phytic acid was measured by Eurofins by the method of stable phytate-iron complex formation in dilute acid solution. Ellis, R., Morris, E. R. & Philpot, C. Quantitative determination of phytate in the presence of high inorganic phosphate. Anal. Biochem. 77, 536-539 (1977).

Papain and subtilisin inhibition assays were performed as previously described. Cupp-Enyard, C. Sigma's Non-specific Protease Activity Assay—Casein as a Substrate. J. Vis. Exp. 899 (2008) doi:10.3791/899. Briefly, inhibitory activity was assessed by incubating 0.5 mL extract of fermented product with 0.5 mL of commercial papain (EC 3.4.22.2) or subtilisin (EC 3.4.21.62) and incubating at 37° C. for 15 min. Then, 5 mL of a casein solution (0.65% w/v) was added to the assay solution and the mixture was further incubated at 55° C. for exactly 10 min. Inhibitory activity was measured by obtaining the difference between the enzyme activity in the absence and in the presence of the fermented protein blend. A substantial reduction in papain inhibition was observed when comparing unfermented (3.4 IU/g protein blend) in comparison to the unfermented (0.6 IU/g protein protein) blend.

Organoleptic Characteristics of Fermented Pea and Rice Protein Concentrate Blend

GC-O and CHARM (Combined Hedonic Aroma Response Measurement) analysis: identification of volatile compounds in fermented and unfermented protein blend samples was done by gas chromatography/olfactometry (GC/O) using human “sniffers” to assay for odor activity among volatile analytes as previously described³³.

Sensory Panel Assessment: The powdered unfermented and fermented protein blend samples were used at 10% in room temperature water and mixed. Sensory testing was performed by Sensations Research using a combination of Spectrum Method™ and Quantitative Descriptive Analysis (QDA). Acree, T. E., Barnard, J. & Cunningham, D. G. A procedure for the sensory analysis of gas chromatographic effluents. Food Chem. 14, 273-286 (1984). Flavor science: sensible principles and techniques. (American Chemical Society, 1993). Trained descriptive panelists used full descriptive analysis technique to develop the language, ballot and rate profiles of the products on aroma. Eleven panelists were trained for 2 sessions with 2 individual evaluations per sample for data collection. Eleven trained panelists (experienced from prior protein consensus panels) evaluated appearance for all samples immediately after mixing to capture initial scores and minimize variability. Data were analyzed using Senpaq: Descriptive Analysis—Analysis of variance (ANOVA).

Organoleptic Characteristics of Fermented Pea and Rice Protein Blend

To characterize and quantify changes in volatile compounds associated with the organoleptic profile of unfermented and fermented pea and rice protein concentrate mixtures, both protein blends were subjected to GC-MS and GC-olfactometry and Combined Hedonic Aroma Response Measurement (CHARM) analyses. The results indicate a decrease in the earthy, beany, potato and mustard off-notes in the fermented protein blend compared to the unfermented, while those associated with fatty and musty are increased. The analysis also indicates an overall change in the relative abundance of volatile compounds in the fermented protein blend as compared to the unfermented one. Several compounds, including galbazine, methyl mercaptan, methional and a sesquiterpene similar to bergamotene (bergamotene-like) were described as imparting unpleasant off-flavors. Specifically, off-notes compounds methional, methyl mercaptan, bergamotene-like compound which are present in the unfermented protein blend were substantially reduced in the fermented protein blend by 40%, 78%, 99% respectively. Moreover, the potent beany off-notes associated with (galbazine) present in the unfermented protein blend were not detected in the fermented sample. To further understand the aroma profile of the fermented and unfermented protein blends, a sensory evaluation was carried out by a trained sensory panel of 11 eleven people. The sensory results correlate well with data from CHARM analysis, indicating a statistically significant decrease in pea and rice notes and overall improvement aroma of the fermented blend. The GC-MS data also reveals a relative increase in the oxylipins: 1-octen-3-one; 2,6-decadienal; 2,4-nonadienal and 2,3 butanedione in the fermented protein blend as compared to the unfermented blend, however this change was not reflected in the sensory profiles provided by the sensory panel. In fact, 2,3 butanedione had a positive impact to the sensory profiling of the fermented protein blend. All together, these results indicate an improvement in the organoleptic characteristic in the fermented pea and rice protein concentration blend versus the unfermented protein blend.

### Discussion

A major disadvantage of plant proteins is their comparatively lower nutritional quality relative to animal derived protein. Results of the ileal digestibility study demonstrated that PDCAAS was greater for the shiitake fermented protein compared with the unfermented protein, which indicates that the fermentation process may have changed the structure of the proteins and thereby made them more digestible. The observations that for both age groups, DIAAS values for the fermented protein was 23-24% greater than for the unfermented protein further indicates that fermentation increased the value of the proteins. Proteins with a DIAAS value between 75 and 100 are considered “good” sources of protein whereas proteins with a DIAAS >100 are considered “excellent” proteins; in this sense, the shiitake fermentation process transformed a good protein source into an excellent one for individuals older than 3 years. The relatively lower increase in PDCAAS versus DIAAS is likely because the fermentation of proteins in the hindgut equalizes the digestibility of protein between different sources even if the ileal digestibility of amino acids is different. The reason the PDCAAS values, regardless of protein and age group, were all greater than the DIAAS values is that although the same scoring pattern was used, the digestibility of crude protein, which is used in the calculation of PDCAAS values, was greater than the digestibility of the first limiting amino acid. However, because the digestibility of amino acids is more correctly estimated by the digestibility of the individual amino acids than by the digestibility of crude protein, the DIAAS values are more representative of the nutritional value of proteins than PDCAAS values.

Several factors might act synergistically to increase the digestibility of the protein blend during the fermentation. Fungi are known to secrete a wide variety of enzymes, including proteases. Shiitake secreted proteases might “pre-digest” the protein substrate before they reach the pig digestive system while the increased solubility of the fermented protein, specially at low pH may partially account for the increasing digestibility. Additionally, the level of the gastric enzymes' inhibitor, phytate, was substantially reduced by the fungal fermentation process. It is very foreseeable that this lower phytate level contributed as well to the observed increase in the pigs' digestibility of the fermented protein blend. Genome searches of different publicly available shiitake genomes indicates that different strains contain at least 5 genes encoding predicted phytases in addition to additional genes encoding potential inositol polyphosphate phosphatases (https://mycocosm.jgi.doe.gov/mycocosm/home). Moreover, the presence of a signal peptide sequence at the N-terminus of most phytases, suggests that shiitake secretes a substantial amount of phytase that could act to degrade phytic acid during fermentation of pea and rice substrates, accounting for the approximately 46% reduction of phytate in the fermented blend. A substantial reduction in cysteine protease inhibition (papain) is observed during the fermentation process. Enzymatic microbial enzymatic activity during fermentation has also been shown to reduce gastric protein inhibitors from plant protein16. On the other hand, the antinutrient papain inhibitor oryzacystatin-I is a protein itself, therefore the denaturation/degradation of this protein during sterilization process of the unfermented pea and rice protein blend could also partially contribute to the reduce enzyme inhibition in the fermented protein blend.

White-rot fungi, such as shiitake, secrete a cocktail of “lignin modifying enzymes” (LME) which catalyze the breakdown of lignin, an amorphous polymer present in the cell wall of plants and the main constituent of wood. LME are oxidizing enzymes and include manganese peroxidase (EC 1.11.1.13), lignin peroxidase (EC 1.11.1.14), versatile peroxidase (EC 1.11.1.16) and laccases (EC 1.10.3.2). Many LME have a low specificity and can oxidize a wide range of substrates with phenolic residues, beside lignin. For example, laccases oxidase a variety of phenolic substrates, performing one-electron oxidations, leading to crosslinking and polymerization of the ring cleavage of aromatic compounds. Fungal laccases and tyrosinases oxidize phenolic residues in protein and carbohydrates present in wheat flour improving its baking properties. Moreover, shiitake laccases have been used to remove off-flavor notes from apple juice. Gene expression profiling (RNA-Seq) indicates that many laccase genes as well as other LMEs are expressed, and a few are upregulated during the shiitake fermentation of pea and rice protein blend (data not shown). Therefore, it is very likely that shiitake LME oxidation of key phenolic residues in the protein blend accounts in part for the reduction/elimination of off-note compounds, resulting in improved organoleptic properties. Other mechanisms such as physical trapping of volatiles and thermal reactions during the sterilization and drying of the protein blends may also contribute to the changes in olfactory character. Further studies on the mode of action and combination of mechanisms responsible for the taste improving capacity of shiitake mycelium fermentation are ongoing.

The benefits of fermentation on pea protein taste and aroma has been demonstrated by Schindler and colleagues. However, to our knowledge, the work presented here is the first successful application of fungal fermentation for the improvement of plant-based protein concentration. The action of the fungal mycelium results in a reduction of compounds negatively impacting the organoleptic characteristics of plant proteins while improving the digestibility and reducing antinutrient contents. This pioneer work will most certainly serve as a basis for future application of mycelial fermentation to improve the quality of low-quality sources to meet the food standards associated with food ingredients.

### Statements Regarding Incorporation by Reference and Variations

All references throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments, exemplary embodiments and optional features, modification and variation of the concepts herein disclosed may be resorted to by those skilled in the art, and that such modifications and variations are considered to be within the scope of this invention as defined by the appended claims. The specific embodiments provided herein are examples of useful embodiments of the present invention and it will be apparent to one skilled in the art that the present invention may be carried out using a large number of variations of the devices, device components, methods steps set forth in the present description. As will be obvious to one of skill in the art, methods and devices useful for the present methods can include a large number of optional composition and processing elements and steps.

Whenever a range is given in the specification, for example, a temperature range, a time range, or a composition or concentration range, all intermediate ranges and subranges, as well as all individual values included in the ranges given are intended to be included in the disclosure. It will be understood that any subranges or individual values in a range or subrange that are included in the description herein can be excluded from the claims herein.

All patents and publications mentioned in the specification are indicative of the levels of skill of those skilled in the art to which the invention pertains. References cited herein are incorporated by reference herein in their entirety to indicate the state of the art as of their publication or filing date and it is intended that this information can be employed herein, if needed, to exclude specific embodiments that are in the prior art. For example, when composition of matter are claimed, it should be understood that compounds known and available in the art prior to Applicant's invention, including compounds for which an enabling disclosure is provided in the references cited herein, are not intended to be included in the composition of matter claims herein.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” may be replaced with either of the other two terms. The invention illustratively described herein suitably may be practiced in the absence of any element or elements, limitation or limitations which is not specifically disclosed herein.

One of ordinary skill in the art will appreciate that starting materials, biological materials, reagents, synthetic methods, purification methods, analytical methods, assay methods, and biological methods other than those specifically exemplified can be employed in the practice of the invention without resort to undue experimentation. All art-known functional equivalents, of any such materials and methods are intended to be included in this invention. The terms and expressions which have been employed are used as terms of description and not of limitation, and there is no intention that in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

We claim:

1. A method to prepare a myceliated high-protein food product, comprising the steps of:
providing an aqueous medium comprising a high-protein material, wherein the aqueous medium comprises at least 50% (w/w) protein on a dry weight basis, wherein the media comprises at least 50 g/L protein and wherein the high protein material is from a plant source;
inoculating the medium with a fungal culture, wherein the fungal culture comprises Lentinula edodes, Agaricus spp., Pleurotus spp., Boletus spp., or Laetiporus spp., and
culturing the medium to produce a myceliated high-protein food product;
wherein the myceliated high-protein food product has increased digestibility as measured by the Digestible Indispensable Amino Acid Score (DIAAS); and/or reduced phytic acid component; and/or reduced oryzacystatin component; and/or reduced undesirable flavors and/or reduced undesirable aromas; as compared to the high-protein material that is not myceliated.

2. The method of claim 1, wherein the Laetiporus spp. is Laetiporus sulfureus.

3. The method of claim 1, wherein the Pleurotus spp. comprises Pleurotus ostreatus, Pleurotus salmoneostramineus (Pleurotus djamor), Pleurotus eryngii, or Pleurotus citrinopileatus.

4. The method of claim 1, wherein the Pleurotus spp. comprises Pleurotus ostreatus or Pleurotus salmoneostramineus (Pleurotus djamor).

5. The method of claim 1, wherein the increase in DIAAS is at least 10% relative to high-protein material that is not myceliated.

6. The method of claim 1, wherein the decrease in phytic acid component is at least 40% and the decrease in the oryzacystatin component is at least 50%, relative to high-protein material that is not myceliated.

7. The method of claim 1, wherein the fungal culture is a submerged fungal culture.

8. The method of claim 1, wherein the high-protein material is a protein concentrate or a protein isolate.

9. The method of claim 8, wherein the high-protein material is from a plant source.

10. The method of claim 9, wherein the plant source comprises pea.

11. The method of claim 1, wherein the myceliated high-protein food product is sterilized or pasteurized prior to the inoculating step.

12. The method of claim 1, wherein the method further comprises the step of drying the myceliated high-protein food product.

13. The method of claim 1, wherein the myceliated high-protein food product has enhanced desirable flavors and enhanced desirable aromas.

14. The method of claim 1, wherein the pH of the fungal culture has a change of less than 0.5 pH units during the myceliation step.

15. The method of claim 1, wherein the culturing step is carried out until the dissolved oxygen in the media reaches between 80% and 90% of the starting dissolved oxygen.

16. The method of claim 1, wherein the pH of the fungal culture has a change of less than 0.3 pH units during the myceliation step.

17. The method of claim 1, wherein the reduced undesirable flavor is a pea flavor or a bitterness flavor.

18. The method of claim 1, wherein the reduced undesirable aroma is a beany aroma or a rice aroma.

19. A myceliated food product made by the method of claim 1.

20. A composition comprising a myceliated high-protein food product, wherein the myceliated high-protein food product is at least 50% (w/w) protein on a dry weight basis, wherein the myceliated high protein food product is derived from a plant source, wherein the myceliated high protein product is myceliated by a fungal culture comprising Lentinula edodes, Agaricus blazeii, Pleurotus spp., Boletus spp., or Laetiporus spp. in a media comprising at least 50 g/L protein, and wherein the myceliated high protein food product has increased digestibility as measured by the Digestible Indispensable Amino Acid Score (DIAAS); and/or reduced phytic acid component; and/or reduced oryzacystatin component; and/or reduced undesirable flavors and/or reduced undesirable aromas; as compared to the high-protein material that is not myceliated compared with a non-myceliated food product.

21. The composition of claim 20, wherein the myceliated high-protein food product is at least 70% (w/w) protein on a dry weight basis.

22. The composition of claim 20, wherein the plant source is pea, rice, or combinations thereof.

23. The composition of claim 20, wherein the myceliated high-protein food product is in the form of a powder.

24. The composition of claim 20, wherein the myceliated high-protein food product is produced according to the method of claim 1.

25. The composition of claim 20, wherein the myceliated high-protein food product has enhanced desirable flavors and enhanced desirable aromas.

26. The composition of claim 20, wherein the increase in DIAAS is at least 10% relative to high-protein material that is not myceliated.

27. The composition of claim 20, wherein the decrease in phytic acid component or the decrease in oryzacystatin component is at least 40% relative to high-protein material that is not myceliated.

28. A food composition comprising the composition of claim 20.
